(19) United States
(12) Patent Application Publication
(10) Pub. No.: US 2025/0164731 A1
(43) Pub. Date: May 22, 2025

(54) FIBER OPTIC SPLICE ORGANIZER

(71) Applicant: CommScope Technologies LLC, Hickory, NC (US)

(72) Inventors: Bart Mattie CLAESSENS, Hasselt (BE); Dirk Jozef G. VAN DE WEYER, Beringen (BE); El Moiz Mohammed Michel GHAMMAM, Brussels (BE)

(73) Assignee: CommScope Technologies LLC, Hickory, NC (US)

(21) Appl. No.: 18/875,634

(22) PCT Filed: Jun. 2, 2023
(86) PCT No.: PCT/US2023/024247

§ 371 Date: Dec. 16, 2024

Related U.S. Application Data
(60) Provisional application No. 63/353,378, filed on Jun. 17, 2022.
(60) Provisional application No. 63/436,356, filed on Dec. 30, 2022.

(51) Int. Cl. G02B 6/44

(52) U.S. Cl. CPC G02B 6/4455

(57) ABSTRACT

A fiber optic splice organizer includes a mounting bracket, and at least one tray attached to the mounting bracket. The tray has a first length and an interior volume for storing fiber optic splices. A modular extension is attachable to the tray to increase the tray length and capacity. And interlocking arrangement including dovetails connects the modular extension to the tray. A cover over the modular extension can include a Sperry screw, alignment posts, and epoxy openings. The cover can include a curved shape over the fiberoptic adapters.

### CROSS-REFERENCE TO RELATED APPLICATIONS

This application is being filed on Jun. 2, 2023, as a PCT International application and claims the benefit of and priority to U.S. Provisional Application No. 63/353,378 filed Jun. 17, 2022 and claims the benefit of U.S. Provisional Application No. 63/436,356 filed Dec. 30, 2022, the disclosures of which are hereby incorporated by reference in their entireties.

### BACKGROUND

Fiber optic telecommunications systems are ubiquitous because of their large information carrying capacity, their virtually noise-free performance, and their ability to carry signals over long distances. Typically, one or more drop locations are included along a fiber optic cable route to deliver fiber optic connectivity to customer locations.

Each drop location or splice point requires the protection of the cable ends and individual splices. Typically, a splice enclosure is provided for terminating the cables and storing the splices. Enclosures for protecting optical fiber splices typically include one or more splice trays on which the individual splices and associated cable slack are mounted. Examples of splice enclosures with splice trays are shown in WO2022/072680A1.

### SUMMARY

In general terms, the present disclosure relates to the storage and organization of fiber optic splices and equipment. In one possible configuration, a fiber optic splice organizer includes a plurality of trays of different sizes for storing fiber optic splices. Various aspects are described in this disclosure, which include, but are not limited to, the following aspects.

One aspect relates to a fiber optic splice organizer comprising: a tray configured for attachment to a mounting bracket and to pivotally move between a stacked position and an unstacked position, the tray including: a base having a first length extending from a proximal end to a distal end, the proximal end of the base being pivotally attached to the mounting bracket by a hinge, and the base further having a width extending between first and second lateral sides of the base; and a sidewall at least partially surrounding the first and second lateral sides and the distal end, the sidewall and the base defining an interior volume for storing fiber optic splices; and a modular extension attached to the distal end of the tray to extend the length of the tray, the modular extension providing a storage area for storing fiber optic equipment. In one example, an interlocking structure including mating dovetail shapes, and retention snaps secures a modular extension to the tray.

Another aspect relates to a fiber optic splice organizer comprising: a tray configured for attachment to a mounting bracket and to pivotally move between a stacked position and an unstacked position, the tray including: a base having a length extending from a proximal end to a distal end, and further having a width extending between first and second lateral sides of the base; and a sidewall at least partially surrounding the first and second lateral sides and the distal end, the sidewall and the base defining an interior volume for storing fiber optic splices; and a modular extension attached to the sidewall at the distal end of the tray to extend the length of the tray, the modular extension having a storage area for storing fiber optic equipment, and the storage area including a platform having fiberoptic adapters on a first side. A curved cover is positioned over the modular extension.

Another aspect relates to modular extension for a fiber-optic splice organizer tray, including a base having a length extending between a proximal end and a distal end along an x-axis, a width extending between first and second lateral sides of the base along a y-axis, and a sidewall at least partially surrounding the first and second lateral sides and the proximal end, the sidewall having a height extending upwardly from the base along a, the sidewall and the base defining an interior volume storing fiber optic equipment, wherein the sidewall defines interlocking structure configured to selectively couple the modular extension to a fiber-optic splice organizer tray, the interlocking structure defining at least one T-shaped retaining member configured to be received within at least one T-shaped retention slot defined by sidewall of the fiber-optic splice organizer tray.

In one embodiment, the interlocking structure further defines at least one T-shaped retaining member configured to be received within at least one T-shaped retention slot defined by sidewall of the fiber-optic splice organizer tray, which in some embodiments can be positioned in proximity to a distal end of the fiber-optic splice organizer tray. In one embodiment, the at least one T-shaped retaining member includes a first extension and a second extension. In one embodiment, the at least one T-shaped retaining member is configured to be slidingly received within the T-shaped retention slot along the z-axis. In one embodiment, the at least one T-shaped retaining member is configured to inhibit relative motion between the modular extension and the fiber optic splice organizer tray along the x- and y-axis.

In one embodiment, the module extension further includes at least one first post receptacle configured to receive at least one first post defined by a sidewall of the fiber-optic splice organizer tray positioned in proximity to a distal end of the fiber-optic splice organizer tray. In one embodiment, the at least one first post receptacle is configured to slidingly engage with the at least one post along the z-axis. In one embodiment, the at least one first post receptacle is configured to inhibit relative motion between the modular extension and the fiber optic splice organizer tray along the x- and y-axis.

In one embodiment, the modular extension further includes at least one second post receptacle configured to receive at least one second post defined by a sidewall of the fiber-optic splice organizer tray positioned in proximity to a distal end of the fiber-optic splice organizer tray. In one embodiment, the at least one first post receptacle and at least one second post receptacle are positioned on opposing sides of an opening defined by the side wall 808 of the modular extension. In one embodiment, the sidewall of the modular extension defines a pair of openings positioned on opposite lateral sides of the modular extension. In one embodiment, the modular extension defines a pair of first post receptacles and a pair of second post receptacles positioned on opposing sides of the pair of openings positioned on opposite lateral sides of the modular extension.

In one embodiment, the modular extension further includes at least one fiber-optic cable organizer defining one or more slots for receiving a fiber optic cable. In one embodiment, n the at least one fiber optic cable organizer defines one or more I-shaped pillars having a first flange to portion and a second flange portion to establish a respective first and second pinch point for retention of a fiber optic cable. In one embodiment, the at least one fiber-optic cable organizer defines three I-shaped pillars. In one embodiment, the at least one cable organizer is positioned adjacent to an opening defined by the sidewall of the modular extension.

In one embodiment, the interlocking structure further defines at least one resilient cantilevered locking tab configured to be received within at least one locking tab slot defined by the sidewall of the fiber-optic splice organizer tray. In one embodiment, the at least one resilient cantilevered locking tab includes a cantilevered arm having a distal end. In one embodiment, the at least one locking tab slot defines a ledge portion configured deflect the cantilevered arm until the distal end of the cantilevered arm passes over the ledge portion, whereupon the cantilevered arm springs back under a natural material resiliency, thereby creating an abutting contact between the distal end of the cantilevered arm and the ledge portion to inhibit movement of the modular extension relative to the fiber-optic splice organizer tray along the z-axis.

In one embodiment, the at least one resilient cantilevered locking tab includes a tool detent into which a tool can be positioned to encourage the coupling of the at least one resilient cantilevered locking tab from the at least one locking tab slot. In one embodiment, the modular extension includes four resilient cantilevered locking tabs. In one embodiment, at least one resilient cantilevered locking tab is positioned on either side of the T-shaped retaining member. In one embodiment, the interlocking structure further defines at least one ledge configured to interact with at least one of the base or side wall of the fiber-optic splice organizer tray to inhibit movement of the modular extension relative to the fiber-optic splice tray organizer along the z-axis.

In one embodiment, the modular extension further includes a cover. In one embodiment, the cover includes at least one alignment pin configured to be received in a corresponding pin socket defined by the modular extension, configured to inhibit movement of the cover relative to the base along the x- and y-axes. In one embodiment, the cover includes three alignment pins configured to be received within three corresponding pin sockets. In one embodiment, the cover includes at least one barbed tab configured to engage with a corresponding engagement surface defined by the modular extension to inhibit movement of the cover relative to the base along the z-axis.

### DESCRIPTION OF THE FIGURES

The following drawing figures, which form a part of this application, are illustrative of the described technology and are not meant to limit the scope of the disclosure in any manner.

FIG. 1 is a sectional, isometric view of a fiber optic splice organizer positioned within an enclosure, the fiber optic splice organizer including a plurality of trays pivotally attached to a bracket, the plurality of trays are shown in a stacked position.

FIG. 2 is a side view of the fiber optic splice organizer of FIG. 1.

FIG. 3 is a front view of the fiber optic splice organizer of FIG. 1.

FIG. 4 is an isometric view of the fiber optic splice organizer showing a first tray of a first type pivoted in an unstacked position, and exposing a first tray of a second type nested within a space defined by another tray of the second type and a modular extension.

FIG. 5 is an isometric view of the fiber optic splice organizer showing the first tray of the first type and the first tray of the second type in the unstacked position, and exposing a second tray of the second type attached to a modular extension.

FIG. 6 is an isometric view of the fiber optic splice organizer showing the first tray of the first type and the first and second trays of the second type in the unstacked position, and exposing a second tray of the first type in the stacked position.

FIG. 7 is an isometric view of an example tray.

FIG. 8 is a top view of the tray of FIG. 7.

FIG. 9 is a proximal end view of the tray of FIG. 7.

FIG. 10 is an isometric view of the tray of FIG. 7 showing a panel of a cover of the tray partially rotated from a closed position to a stowed position.

FIG. 11 is an isometric view of the tray of FIG. 7 showing the panel of FIG. 10 in the stowed position such that the panel faces a bottom surface of the tray.

FIG. 12 is a proximal end view of the tray of FIG. 7 showing one panel in the stowed position, and another panel partially rotated from the closed position to the stowed position.

FIG. 13 is a bottom, isometric view of the tray of FIG. 7 with both panels in the stowed position, and facing the bottom surface of the tray.

FIG. 14 is a detailed view of channels defined by attachment members on the tray of FIG. 7 where the panels of the cover rotate between the closed and stowed positions.

FIG. 15 is a top view of the tray of FIG. 7 with both panels in the stowed position.

FIG. 16 is a partial, isometric view of a distal end of the tray of FIG. 7.

FIG. 17 is an isometric view of a proximal end of a modular extension.

FIG. 18 is an isometric view of the proximal end of the modular extension of FIG. 17 showing a storage area of the modular extension that includes a platform having first and second rows of adapters, and with the first row of adapters being pivoted upwards.

FIG. 19 is an isometric view of the proximal end of the modular extension of FIG. 17 showing the second row of adapters of the platform being pivoted upwards.

FIG. 20 is a top view of the modular extension of FIG. 17.

FIG. 21 is a forward, isometric view of the distal end of the tray of FIG. 7 with the modular extension of FIG. 17 attached thereto.

FIG. 22 is a rearward, isometric view of the distal end of the tray of FIG. 7 with the modular extension of FIG. 17 attached thereto.

FIG. 23 is a side view of the modular extension of FIG. 17.

FIG. 24 is an exploded view of the tray of FIG. 7 and modular extension of FIG. 17.

FIG. 25 is a detailed view of a label area on the tray of FIG. 7.

FIG. 26 is an isometric view of another example of a modular extension attached to a tray that can pivotally attach to the bracket of the fiber optic splice organizer of FIG. 1.

FIG. 27 is an exploded isometric view of the modular extension and tray of FIG. 26.

FIG. 28 is a side view of the modular extension and tray of FIG. 26.

FIG. 29 is a top view of the modular extension of FIG. 26 with a cover removed therefrom, exposing a splitter having at least one splitter input and a plurality of splitter outputs.

FIG. 30 is a top view of the modular extension and tray of FIG. 26 with the cover attached to the modular extension, and showing the splitter input and outputs organized by cable managers on the tray.

FIG. 31 is an isometric view of another example of a tray and a modular extension.

FIG. 32 is a top view of the tray and modular extension of FIG. 31.

FIG. 33 is an isometric view as in FIG. 31 with the respective covers removed.

FIG. 34 is a top view of FIG. 33.

FIG. 35 is a bottom isometric of the tray and modular extension of FIG. 31.

FIG. 36 is a first exploded isometric view of the tray and modular extension of FIG. 31.

FIG. 37 is a further exploded isometric view of the tray and modular extension of FIG. 31.

FIG. 38 is an exploded isometric view of modular extension of FIG. 31.

FIG. 39 is a further exploded isometric view of the modular extension.

FIG. 40 is an enlarged top view of the interlocking structures of the modular extension and the tray of FIG. 31.

FIG. 41 is an end view of the tray showing the interlocking structures of the tray.

FIG. 42 is an end view of the modular extension showing the interlocking structures of modular extension.

FIG. 43 is an isometric view of the modular extension.

FIG. 44 is an enlarged view of a portion of the modular extension noted in FIG. 43 showing a crush rib.

FIGS. 45 and 46 show the tray and modular extension of FIG. 31 in a top view and in a side view.

FIGS. 47-50 show a modified tray connected to the modular extension of FIGS. 31-46.

FIGS. 51-54 show a modified modular extension mounted to the tray of FIGS. 31-46.

FIGS. 55-58 show the modified modular extension of FIGS. 1-54 mounted to the modified tray of FIGS. 47-50.

FIGS. 59 and 60 show an end view of the modified modular extension of FIGS. 51-54, shown with a cover (FIG. 59) and without the cover (FIG. 60).

FIG. 61 shows the modified modular extension and tray of FIGS. 51-54, with a cover of the modified modular extension in exploded view.

FIG. 62 is a perspective view depicting a modular extension, in accordance with an embodiment of the disclosure.

FIG. 63 is a perspective view depicting the modular extension of FIG. 62 in combination with a tray, in accordance with an embodiment of the disclosure.

FIG. 64 is a profile view depicting an interconnection between a modular extension and tray, in accordance with an embodiment of the disclosure.

FIG. 65 is a perspective view depicting a tray, in accordance with an embodiment of the disclosure.

FIGS. 66-72 are close-up views depicting an interconnectability between a modular extension and a tray, in accordance with an embodiment of the disclosure.

FIG. 73 is a perspective view depicting a modular extension and tray, in accordance with an embodiment of the disclosure.

FIG. 74 is a perspective view depicting a modular extension and tray, in accordance with an embodiment of the disclosure.

FIG. 75 is a perspective view depicting a modular extension and tray, in accordance with an embodiment of the disclosure.

FIG. 76 is a perspective view depicting a modular extension and tray, in accordance with an embodiment of the disclosure.

FIG. 77 is a perspective view depicting a modular extension and tray, in accordance with an embodiment of the disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

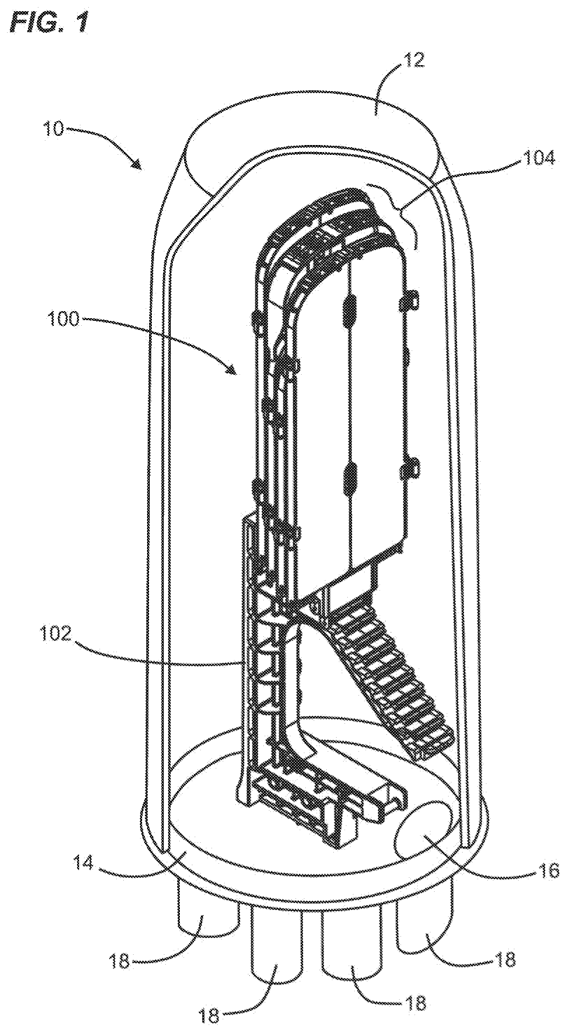

FIG. 1 is a sectional, isometric view of a splice organizer 100 positioned inside an enclosure 10. The enclosure 10 includes a protective housing 12 attached to an end cap 14, and that together with the end cap 14 defines an interior volume 20. In the example shown in FIG. 1, the protective housing 12 has a substantially dome shape.

A mounting bracket 102 secures the splice organizer 100 to the end cap 14. Fiber optic cables enter the enclosure 10 through one or more cable ports 18 that extend from an exterior surface of the end cap 14, and through one or more openings 16 on an interior surface of the end cap 14 that provide access to the interior volume 20.

A plurality of trays 104 are pivotally attached to the mounting bracket 102, and the mounting bracket 102 is attached to an interior surface of the end cap 14. The plurality of trays 104 are pivotally moveable between stacked and unstacked positions to provide access to the contents of each tray. In FIG. 1, the plurality of trays 104 are shown in a stacked position.

The protective housing 12 is sealed to the end cap 14 after splicing operations on the fiber optic cables are completed, and the splices are stored on the trays 104. The protective housing 12 protects the splice organizer 100 from outside elements such as water, moisture, dirt, and the like. The enclosure 10 can be fixed to a pole line such that the enclosure 10 can be installed aerially, or the enclosure 10 can be installed underground in a manhole or directly buried in the ground, as well as in other suitable locations.

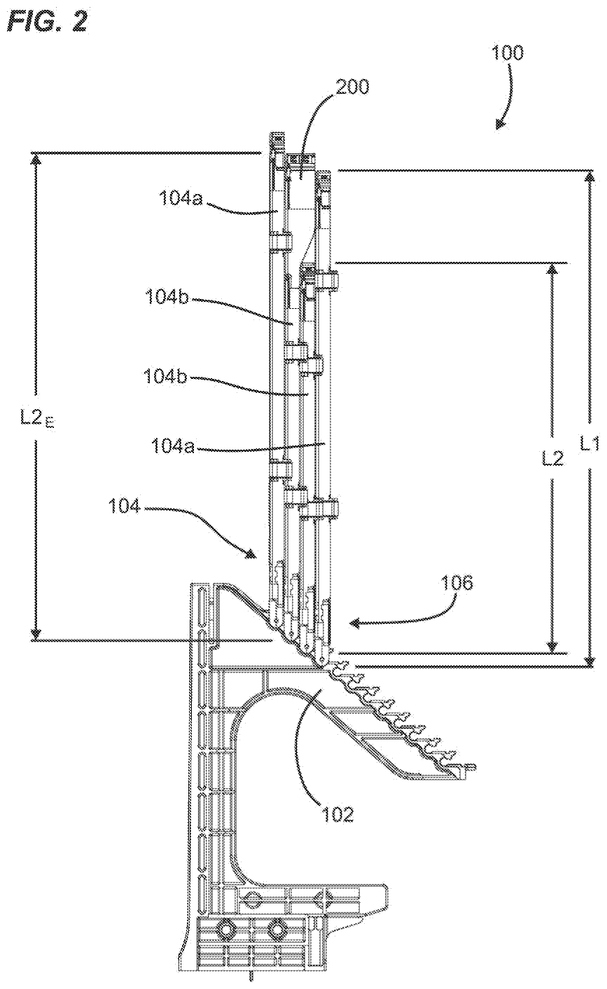

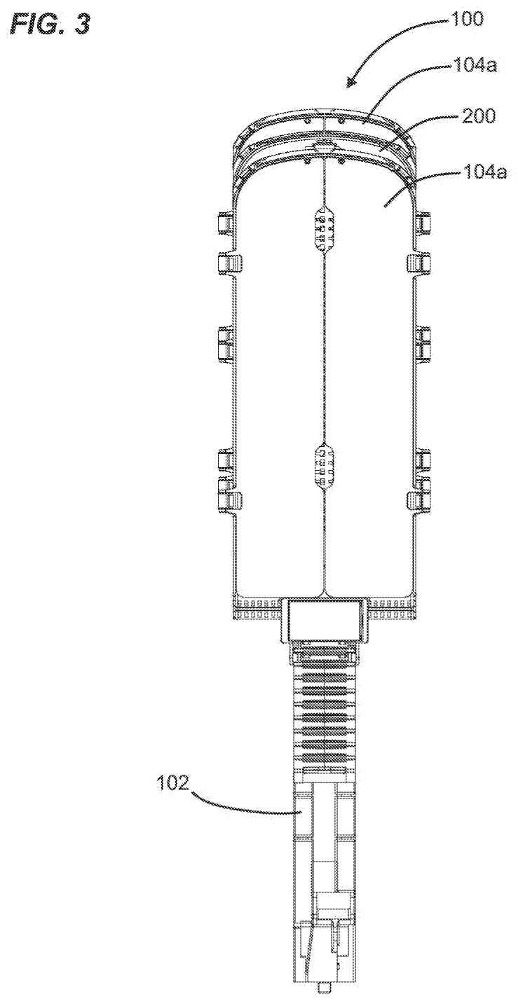

FIGS. 2 and 3 are side and front views of the splice organizer 100, respectively. As shown in FIGS. 2 and 3, the splice organizer 100 includes at least one tray of a first type 104a and at least one tray of a second type 104b. In the example embodiment shown in the figures, two trays of the second type 104b are sandwiched between two trays of the first type 104a.

The tray of the first type 104a has a length L1, and the tray of the second type 104b has a length L2. In this example, the length L1 is longer than the length L2. Thus, the trays of the first and second type 104a, 104b have different lengths. In some examples, the length L1 can range from about 420 mm to about 170 mm. In certain examples, the length L1 can range from about 330 mm to about 230 mm. In some examples, the length L2 can range from about 330 mm to about 170 mm. Additional lengths for the trays of the first and second type 104a, 104b are possible, and the lengths specified herein are provided for illustrative purposes only.

Due to the longer length L1 of the tray of the first type 104a than the length L2 of the tray of the second type 104b, the tray of the first type 104a has a capacity for storing a larger quantity of fiber optic splices than the tray of the second type 104b. In certain examples, the first type 104a has a capacity for storing about 576 to about 24 fiber optic splices, and the tray of the second type 104b has a capacity for storing about 96 to about 24 fiber optic splices. Additional storage capacities for the trays of the first and second type 104a, 104b are possible, and the storage capacities specified herein are provided for illustrative purposes only.

While the splice organizer 100 is described herein as having at least one tray of a first type 104a and at least one tray of a second type 104b, it is contemplated that the splice organizer 100 may include a plurality of each of the first and second type 104a, 104b of trays. For example, the splice organizer 100 shown in FIGS. 1-3 includes first and second trays of the first type 104a, and first and second trays of the second type 104b.

The splice organizer 100 can include additional types of trays of different lengths in addition, or alternatively to the trays of the first and second type 104a, 104b shown in FIGS. 1-3. For example, the splice organizer 100 can further include at least one tray of a third type pivotally attached to the mounting bracket 102 that has a length L3 for storing a third amount of fiber optic splices, the splice organizer 100 can further include at least one tray of a fourth type pivotally attached to the mounting bracket 102 that has a length L4 for storing a fourth amount of fiber optic splices, and can further include at least one tray of a fifth type pivotally attached to the mounting bracket 102 that has a length L5 for storing a fifth amount of fiber optic splices.

In certain examples, the length L3 of the trays of the third type can range from about 420 mm to about 320 mm. In certain examples, the length L4 of the trays of the fourth type can range from about 330 mm to about 230 mm. In certain examples, the length L5 of the trays of the fifth type can range from 240 mm to about 170 mm.

Still referring to FIGS. 1-3, a modular extension 200 is attached to one of the trays of the second type 104b. The modular extension 200 increases the length L2 of the tray of the second type 104b to an extended length L2E to increase the capacity of the tray to store additional fiber optic splices, devices, tools, equipment, and the like. The modular extension 200 provides a storage area for fiber optic equipment. In certain examples, the storage area provided by the modular extension 200 can be used to store one or more patch cord connectors.

When the modular extension 200 is attached to the tray of the second type 104b, the extended length L2E can be shorter than, equal to, or longer than the length L1 of the tray of the first type 104a. In certain examples, the length L2E is about the same as the length L1. In certain examples, the length L2E can range from about 420 mm to about 170 mm.

While the modular extension 200 is shown attached to the tray of the second type 104b, the modular extension 200 can also be attached to one or more of the trays of the first type 104a to extend the length and capacity of these trays. Additionally, the modular extension 200 can be attached to the trays of the third, fourth, or fifth type to increase the length and capacity of these trays. The modular extension 200 will be described in more detail below.

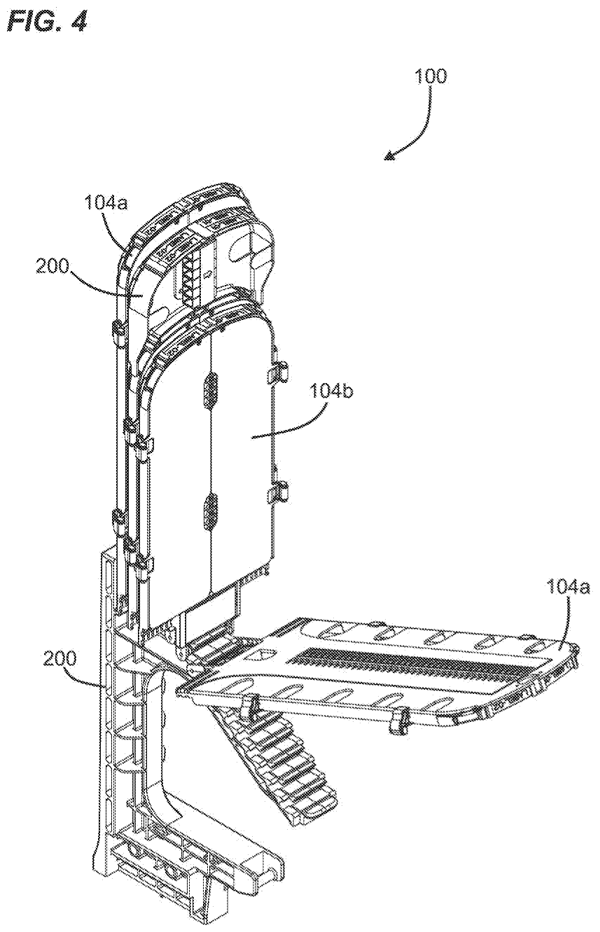

FIG. 4 is an isometric view of the splice organizer 100 showing a first tray of the first type 104a pivoted in an unstacked position 108, and exposing a first tray of the second type 104b nested within a space defined by another tray of the second type 104b and the modular extension 200. Referring now to FIGS. 1-4, the first tray of the first type 104a and the first tray of the second type 104b are attached to the mounting bracket 102 such that the first tray of the first type 104a at least partially overlaps the first tray of the second type 104b when both trays are in the stacked position 106, and the first tray of the first type 104a is pivotally moveable from the stacked position 106 to the unstacked position 108 such that the first tray of the first type 104a no longer overlaps the first tray of the second type 104b to provide access to the fiber optical splices and other fiber optic equipment held on the first tray of the second type 104b.

Alternatively, the first tray of the first type 104a and the first tray of the second type 104b can be attached to the mounting bracket 102 such that the first tray of the second type 104b at least partially overlaps the first tray of the first type 104a, and the first tray of the second type 104b is pivotally moveable from the stacked position 106 to the unstacked position 108 to provide access to the fiber optical splices on the first tray of the first type 104a.

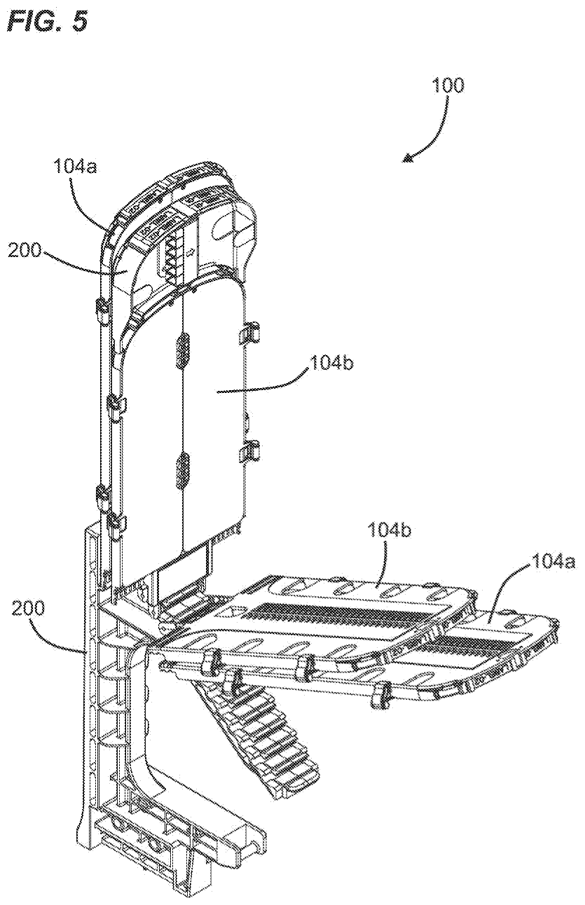

FIG. 5 is an isometric view of the splice organizer 100 showing the first tray of the first type 104a and the first tray of the second type 104b in the unstacked position 108, and exposing a second tray of the second type 104b attached to a modular extension 200 in the stacked position 106. As shown in FIGS. 1-5, the first trays of the first and second type 104a, 104b are both pivotally moveable from the stacked position 106 to the unstacked position 108 to provide access to the fiber optical splices on the second tray of the second type 104b, and the fiber optic equipment stored on the modular extension 200 such as patch cord connectors.

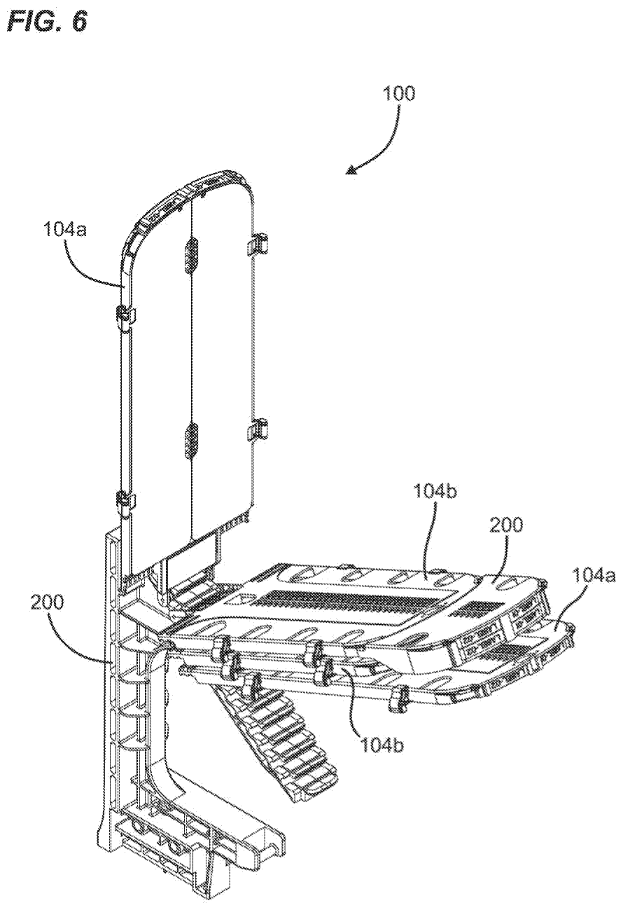

FIG. 6 is an isometric view of the splice organizer 100 showing the first tray of the first type 104a and the first and second trays of the second type 104b in the unstacked position 108, and exposing a second tray of the first type 104a in the stacked position 106. As shown in FIGS. 1-6, the first tray of the first type 104a and the first and second trays of the second type 104b are pivotally moveable from the stacked position 106 to the unstacked position 108 to provide access to the fiber optical splices on the second tray of the first type 104a.

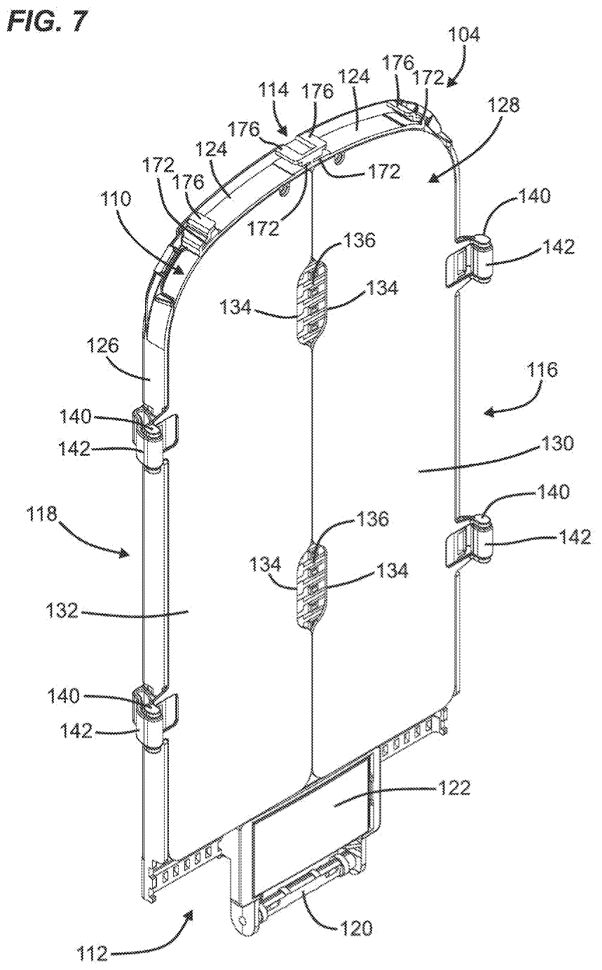

FIGS. 7-9 are isometric, top, and proximal end views of an example embodiment of a tray 104. The following description of the tray 104 is applicable to the trays of the first and second type 104a, 104b described above, as well as trays having additional sizes such as the trays of the third, fourth, and fifth types that are described above.

Referring now to FIGS. 7-9, the tray 104 has a base 110 that extends from a proximal end 112 to a distal end 114, and that has first and second lateral sides 116, 118. As shown in FIG. 8, the base 110 has a length L that is defined by a distance between the proximal end 112 and the distal end 114, and a width W that is defined by a distance between the first and second lateral sides 116, 118. In the example shown in the figures, the base 110 has a substantially rectangular shape. In certain examples, the length L of the base 110 can range from about 370 mm to about 120 mm. In certain examples, the width W of the base 110 can range from about 150 mm to about 110 mm. Additional dimensions for the length L and width W of the base 110 are possible, and the dimensions specified herein are provided for illustrative purposes only.

A hinge 120 is attached to the proximal end 112 of the base 110. The hinge 120 is used to pivotally attach the tray 104 to the mounting bracket 102.

As shown in FIGS. 7 and 8, a label area 122 is provided on the hinge 120 where the tray 104 attaches to the mounting bracket 102. The label area 122 is configured to secure a label to the tray 104 to identify the contents of the tray 104.

As shown in FIGS. 7-9, the tray 104 further includes at least one label area 124 at the distal end 114 of the base 110. The label area 124 is defined by a front portion of a sidewall 126 at the distal end 114 of the tray 104. The label area 124 is configured to hold a label for identifying the tray 104 and the contents thereon. Additionally, the label area 124 is structured to provide a space for connecting the modular extension 200 to the tray 104.

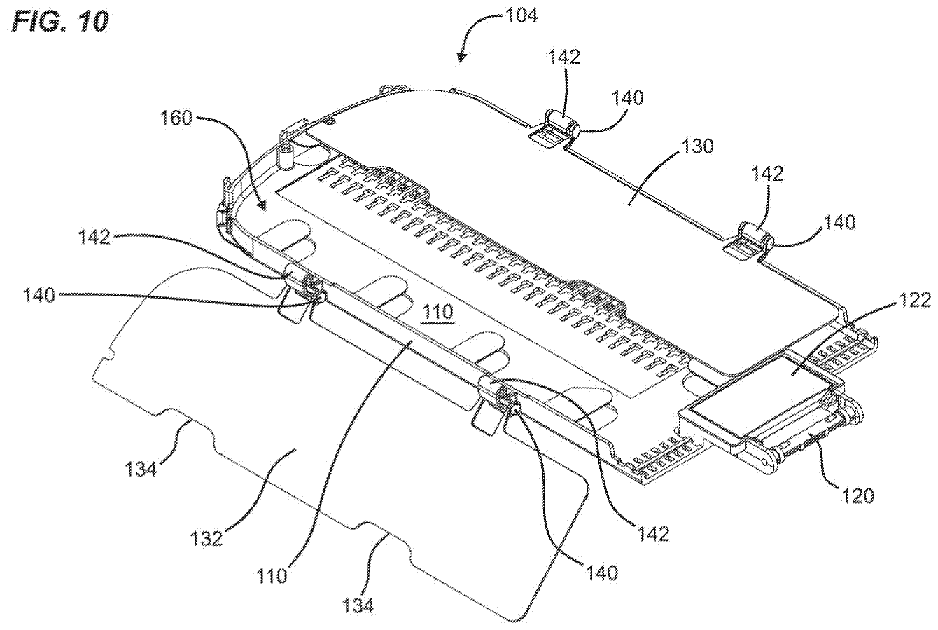

Still referring to FIGS. 7-9, the tray 104 incudes a cover 128 that encloses an interior volume 160 of the tray defined by the base 110 and the sidewall 126. In the embodiment depicted in the figures, the cover 128 includes a first panel 130 attached to the first lateral side 116 of the tray 104 and a second panel 132 attached to the second lateral side 118 of the tray 104. As shown in FIGS. 7 and 8, the first and second panels 130, 132 can each include one or more grooves 134 that allow a technician to grasp the first and second panels 130, 132. For example, when the first and second panels 130, 132 are in a closed position, as shown in FIGS. 7 and 8, the grooves 134 each partially define an aperture 136 in which the technician can place a hand or fingers therein to grasp the first and second panels 130, 132, and to rotate them from the closed position shown in FIGS. 7 and 8 to a stowed position, as shown in FIGS. 10-13.

The first and second panels 130, 132 each include one or more attachment members 140 that rotate and slide inside attachment members 142 on the first and second lateral sides 116, 118 of the tray 104. The attachment members 140, 142 allow the first and second panels 130, 132 to rotate and slide from facing a top surface 150 of the tray 104 to facing a bottom surface 152 of the tray 104. In FIGS. 7-9, the first and second panels 130, 132 block access to the interior volume 160 when the first and second panels 130, 132 are in the closed position.

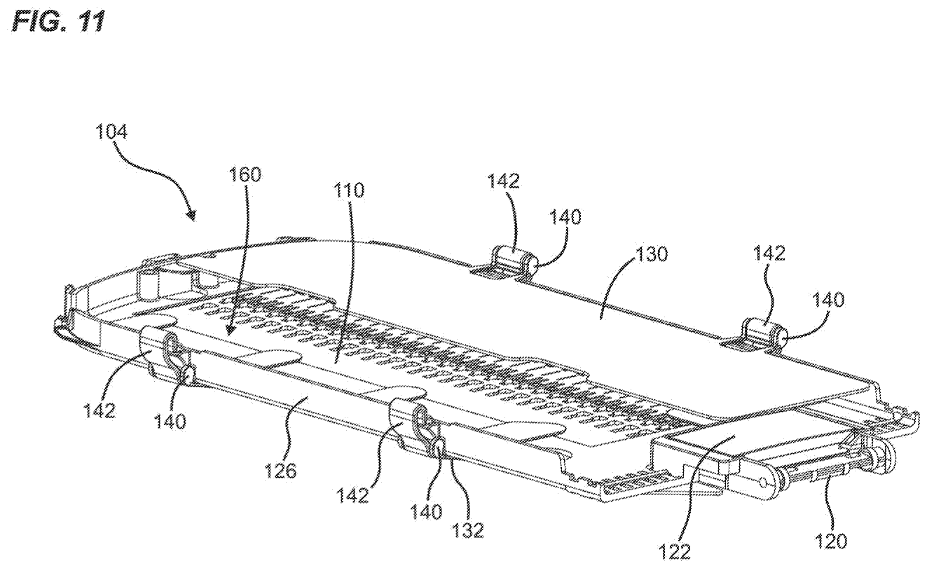

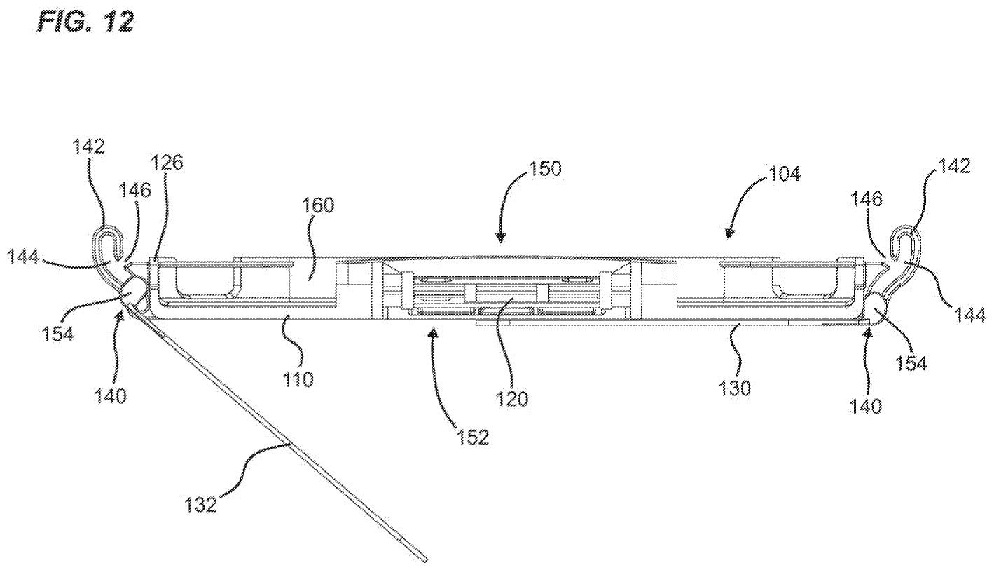

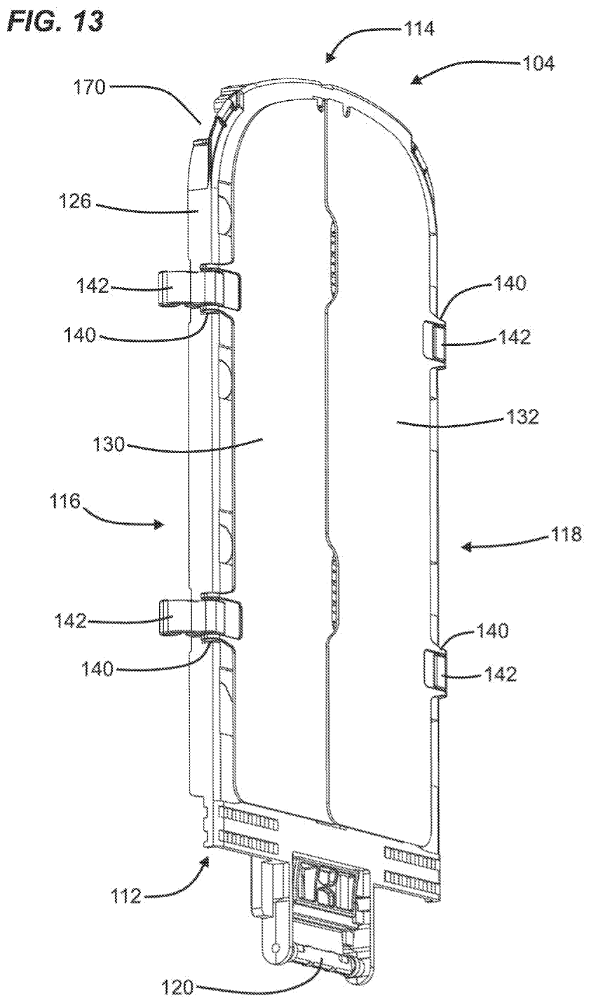

FIG. 10 is an isometric view of the tray 104 showing the second panel 132 partially rotated from the closed position to a stowed position. FIG. 11 is an isometric view of the tray 104 showing the second panel 132 in the stowed position such that the second panel 132 faces the bottom surface 152 of the tray 104. FIG. 12 is a proximal end view of the tray 104 showing the first panel 130 in the stowed position, and the second panel 132 partially rotated from the closed position to the stowed position. FIG. 13 is an isometric, bottom view of the tray 104 with both the first and second panels 130, 132 in the stowed position. The first and second panels 130, 132 allow access to the interior volume of the tray 104 when in the stowed position.

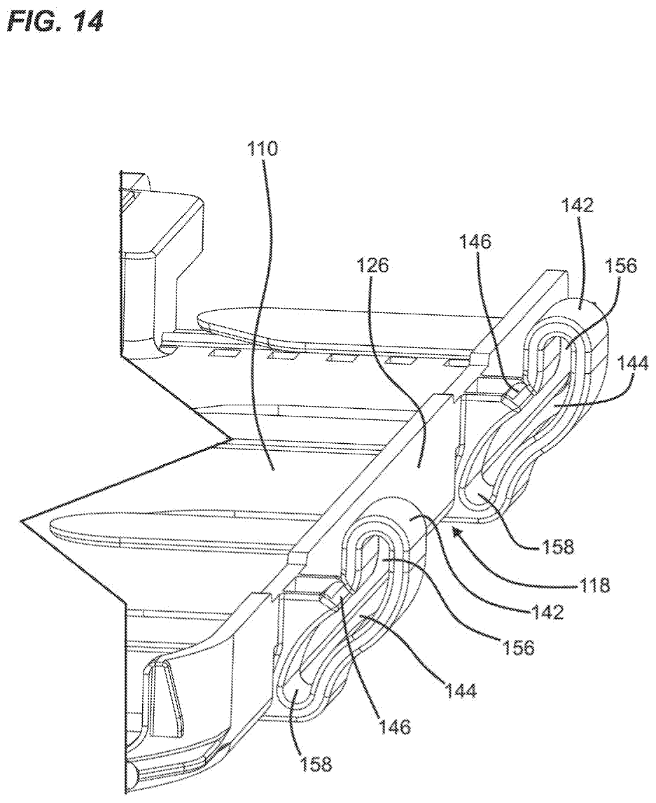

FIG. 14 is a detailed view of the attachment members 142 provided on the second lateral side 118 of the tray 104. Referring now to FIGS. 7-14, the attachment members 140 on the first and second panels 130, 132 are configured to rotate and slide inside channels 144 defined by the attachment members 142 to change the position and orientation of the first and second panels 130, 132 from the closed position to the stowed position. The attachment members 142 on the first and second lateral sides 116, 118 of the tray 104 prevent the first and second panels 130, 132 from becoming detached from the tray 104 when in the stowed position. This is advantageous because when the enclosure 10 is installed in the field (e.g., when it is fixed to a pole line), the first and second panels 130, 132 will not fall to the ground, making it easier for a technician to work on the tray 104 without having to worry about re-attaching the panels.

The attachment members 142 on the first and second lateral sides 116, 118 each include a slot 146 that allows the attachment members 140 on the first and second panels 130, 132 to be disengaged from the channel 144, and to thereby allow the first and second panels 130, 132 to be removed from the tray 104 without requiring the use of any tools.

Still referring to FIG. 14, each channel 144 includes a first end 156 and a second end 158 that have shapes that correspond to the attachment members 140 on the first and second panels 130, 132. The shape of the first and second ends 156, 158 allows the first and second panels 130, 132 to lock in the closed and stowed positions. For example, as shown in FIG. 12, the shape of the second end 158 corresponds to a lobe 154 of the attachment member 140 of the first panel 130 that allows the first panel 130 to be locked in the stowed position and remain parallel to the bottom surface 152. This is advantageous because by locking the first and second panels 130, 132 to remain parallel to the bottom surface 152, the first and second panels 130, 132 will not dangle downwardly due to gravity, and instead, will be held against the bottom surface 152 to avoid interference with the other trays pivotally attached to the mounting bracket 102.

In the embodiment depicted in the figures, the attachment members 142 on the tray 104 define the channels 144 in which the attachment members 140 on the first and second panels 130, 132 rotate and slide. In alternative embodiments, the attachment members 140 on the first and second panels 130, 132 can define the channels 144, and the attachment members 142 on the tray 104 rotate and slide within the channels 144 defined by the attachment members 140.

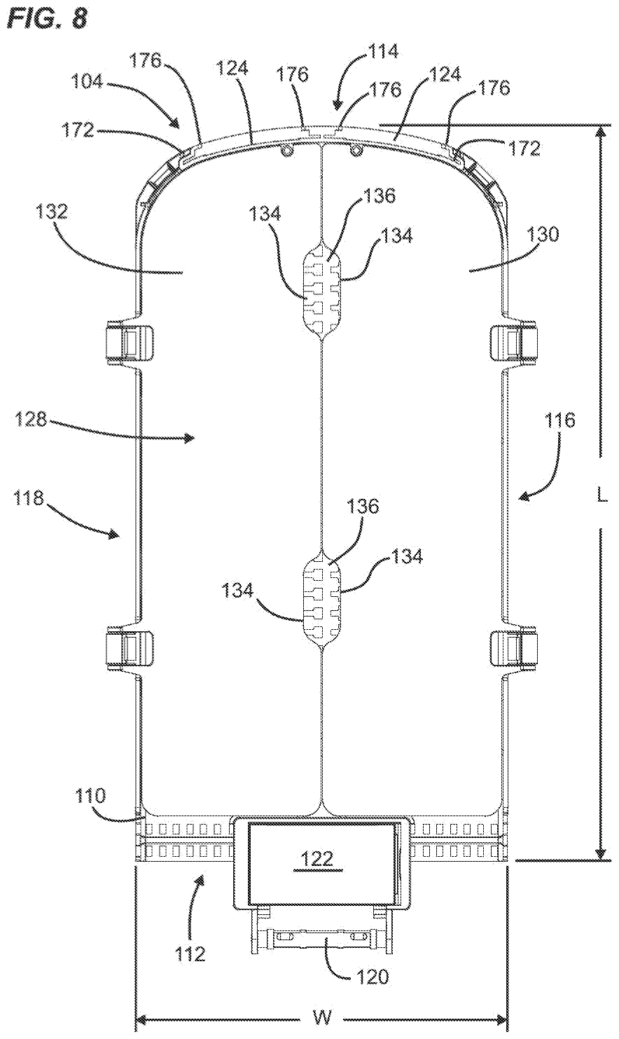

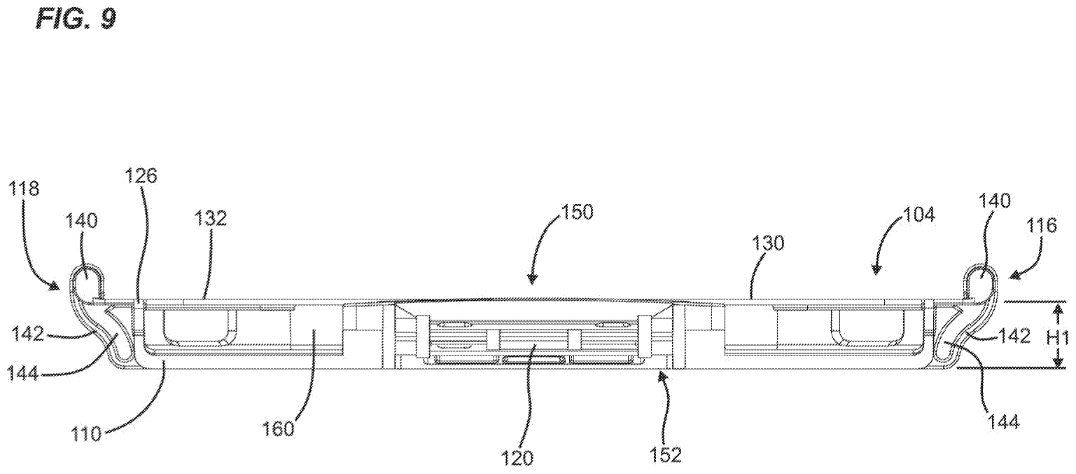

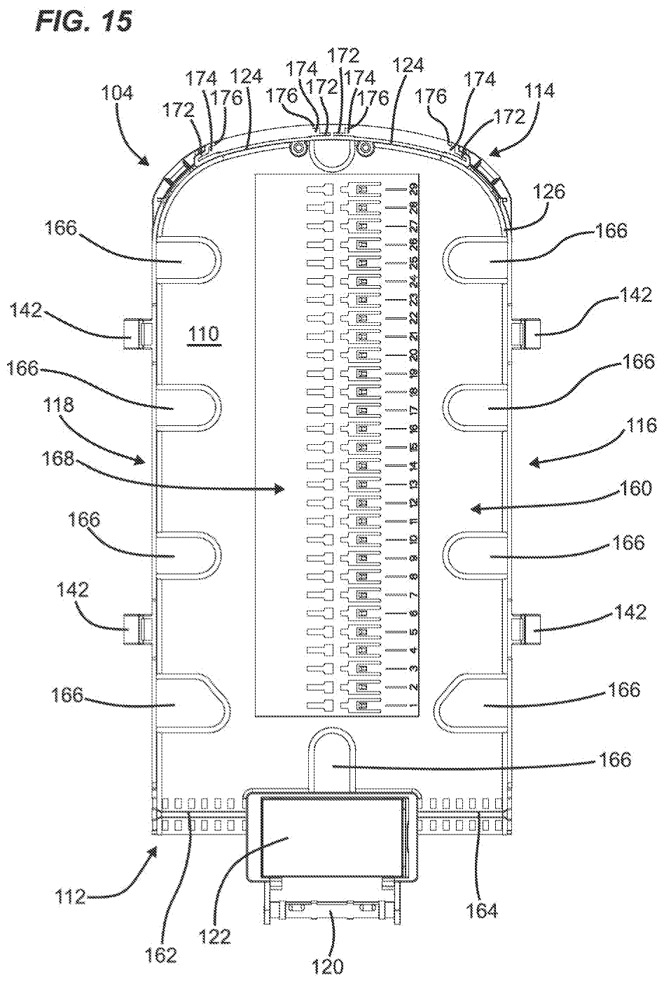

FIG. 15 is a top view of the tray 104 with both the first and second panels 130, 132 in the stowed position. Referring now to FIG. 15, the sidewall 126 surrounds at least the distal end 114 and first and second lateral sides 116, 118 of the base 110. As shown in FIG. 9, the sidewall 126 of the tray 104 has a height H1. As described above, the base 110 and the sidewall 126 define an interior volume 160 of the tray 104 that is configured to store fiber optic splices and fiber optic cable slack, as well as other fiber optic devices, tools, equipment, and the like.

The proximal end 112 of the base 110 includes openings 162, 164 on opposite sides of the hinge 120 where the base 110 pivotally attaches to the mounting bracket 102. Also, the label area 122 is located on the hinge 120 at the proximal end 112. As described above, the label area 122 is configured to secure a label to the tray to identify the contents of the tray 104.

Fiber optic cables enter the interior volume 160 through the openings 162, 164 at the proximal end 112 of the tray 104. Cable managers 166 extend from the sidewall 126 across a portion of the base 110. The cable managers 166 can aid in retaining slack portions of the fiber optic cables within the interior volume 160 defined by the sidewall 126 and base 110 of the tray 104. In some examples, the cable managers are guide tabs.

The base 110 further includes a plurality of splice holders 168. In the embodiment depicted in the figures, the plurality of splice holders 168 are arranged in a linear row that extends from the proximal end 112 to the distal end 114 of the base 110. Alternative arrangements for organizing the plurality of splice holders 168 on the base 110 are possible.

In some example embodiments, the interior volume 160 of the tray 104 has a capacity for about 36-40 splice holders 168. In some example embodiments, the interior volume 160 of the tray 104 has a capacity for storing about 26-32 splice holders 168.

During operation, optical fibers from the fiber optic cables that enter the interior volume 160 are spliced together. Thereafter, the splices are held and supported by the splice holders 168 on the base 110. The splice holders 168 can secure several splices in side-by-side relation. Advantageously, the splice holders 168 securely hold the splices and prevent damage to the splices that can be caused by mechanical shock and vibration. The splice holders 168 can accommodate a variety of different splice sizes and shapes with different external dimensions. Many different splice holders could be used as suggested by those skilled in the art.

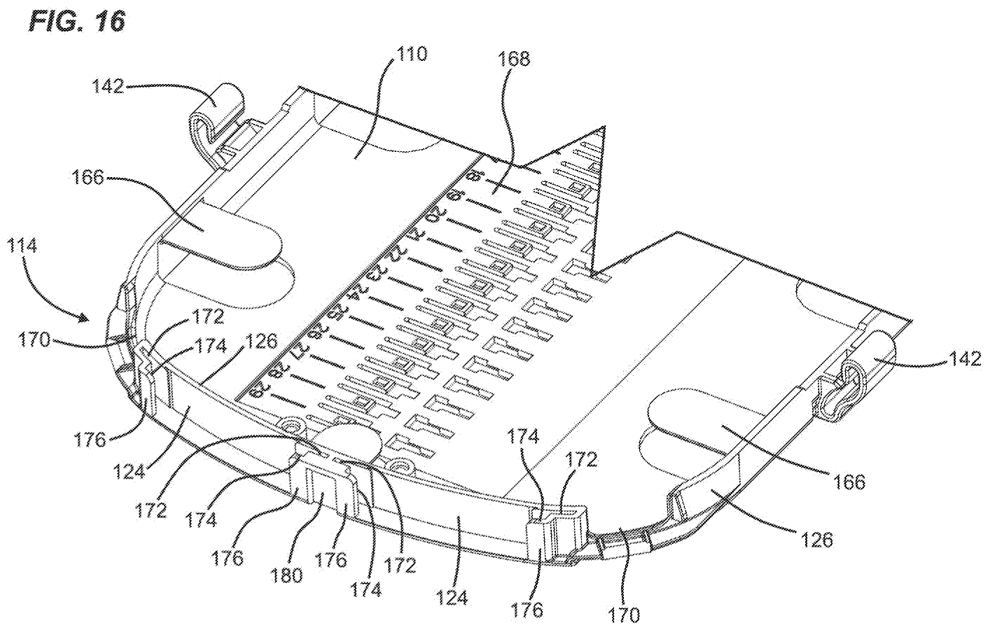

FIG. 16 is an isometric view of the distal end 114 of the tray 104. Referring now to FIGS. 15 and 16, the sidewall 126 at the distal end 114 of the tray 104 includes one or more label areas 124 for securing one or more labels to the distal end 114 of the tray 104. Each label area 124 is a pocket defined in the sidewall 126 that includes slots 172 on opposite sides thereof.

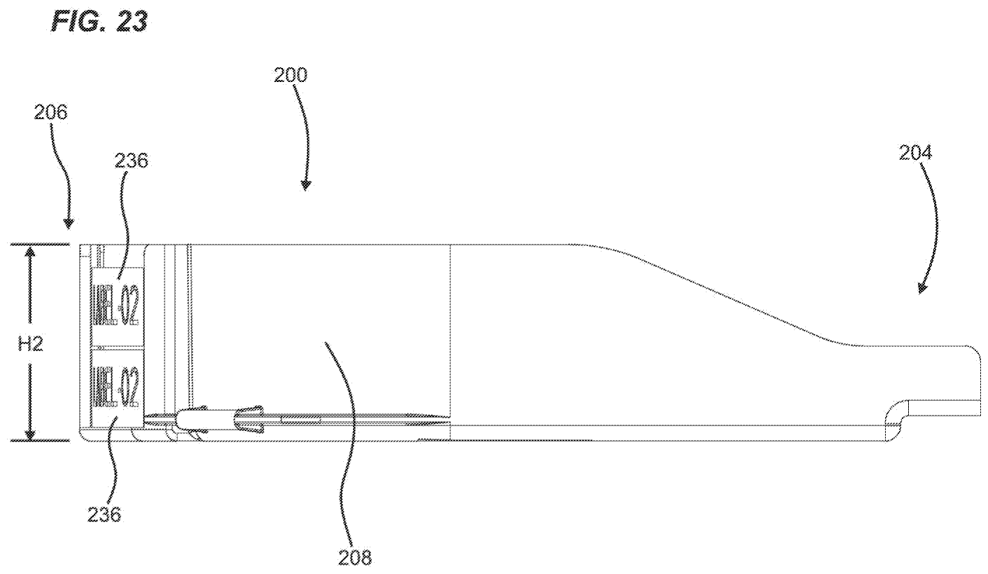

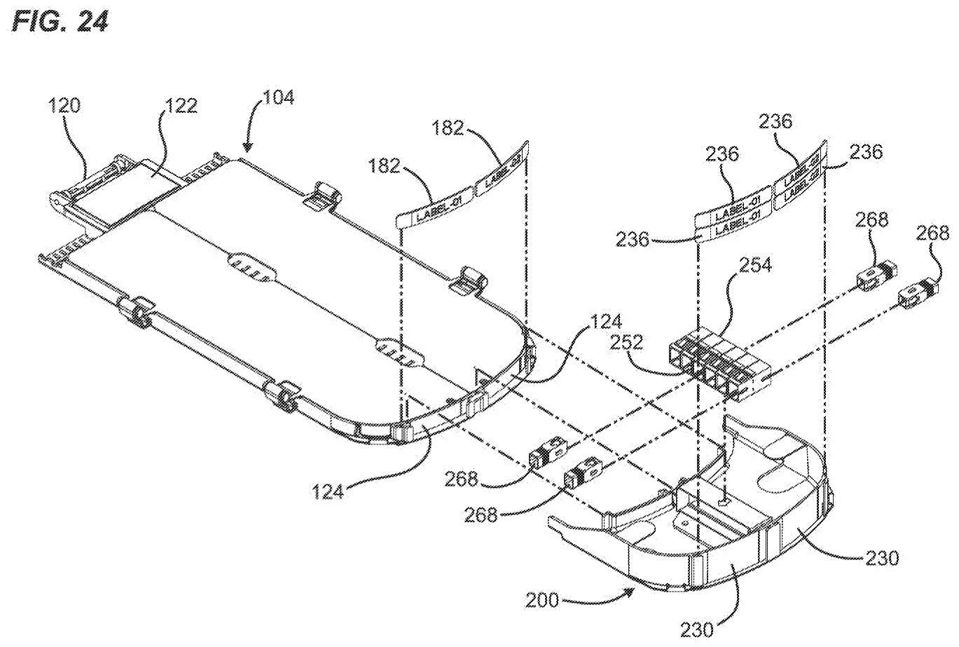

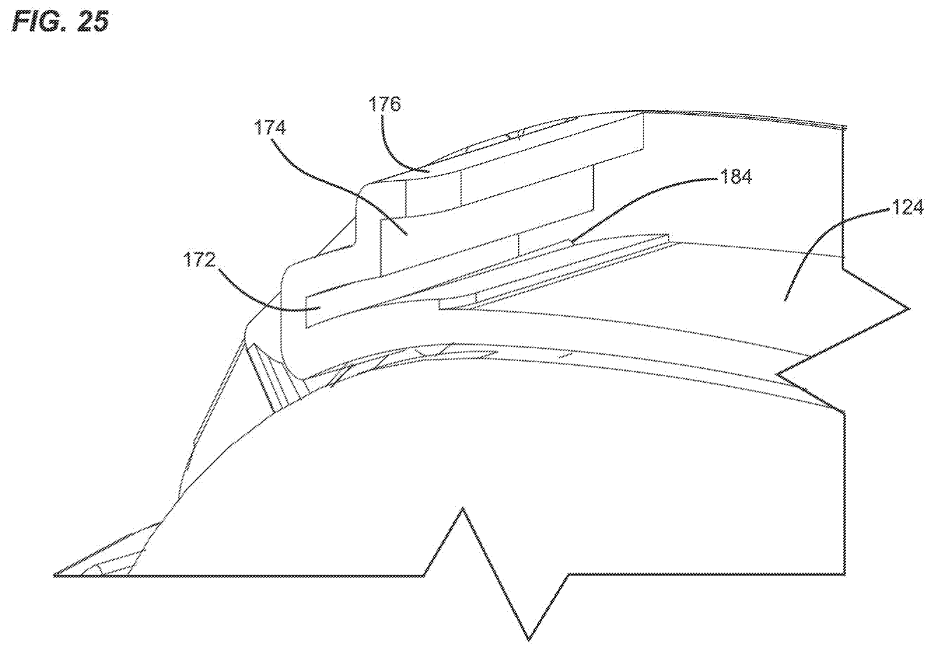

FIG. 24 is an exploded view of the tray 104 showing the insertion of the labels 182 into the label areas 124 of the tray 104. FIG. 25 is a detailed view of a slot 172 of a label area 124 of the tray 104. Referring now to FIGS. 15, 16, 24, and 25, each slot 172 can include a retention member 184 that retains the ends of a label 182 inside a label area 124 by friction. Advantageously, this can prevent the label 182 from accidentally sliding out of the label area 124 when the tray 104 is pivoted into the unstacked position, such as shown in FIG. 4. In the example shown in FIG. 25, each retention member 184 can have a sloped surface that gradually increases toward an interior of the label area 124 such that when a label 182 is inserted into the label area 124, the ends of the label are retained inside the label area 124 by friction. When desired, the label 182 can be removed from the label area 124 by pulling the label out of the label area 124.

In the embodiment depicted in the figures, the sidewall 126 includes two separate label areas 124 for securing two labels to the tray 104. The labels secured to the tray 104 by the slots 172 can be used to identify the tray 104 and the contents stored thereon.

As further shown in FIG. 16, the distal end 114 of the tray 104 includes slots 174 that are each defined by a tab 176 on the sidewall 126. The slots 174 are positioned in front of the label areas 124. The distal end 114 of the tray 104 further includes a receptacle 180 on the sidewall 126. As will be described in more detail, the slots 174 and the receptacle 180 allow the proximal end 204 of the modular extension 200 to be removably attached to the distal end 114 of the modular extension 200 to extend the length and storage capacity of the tray 104.

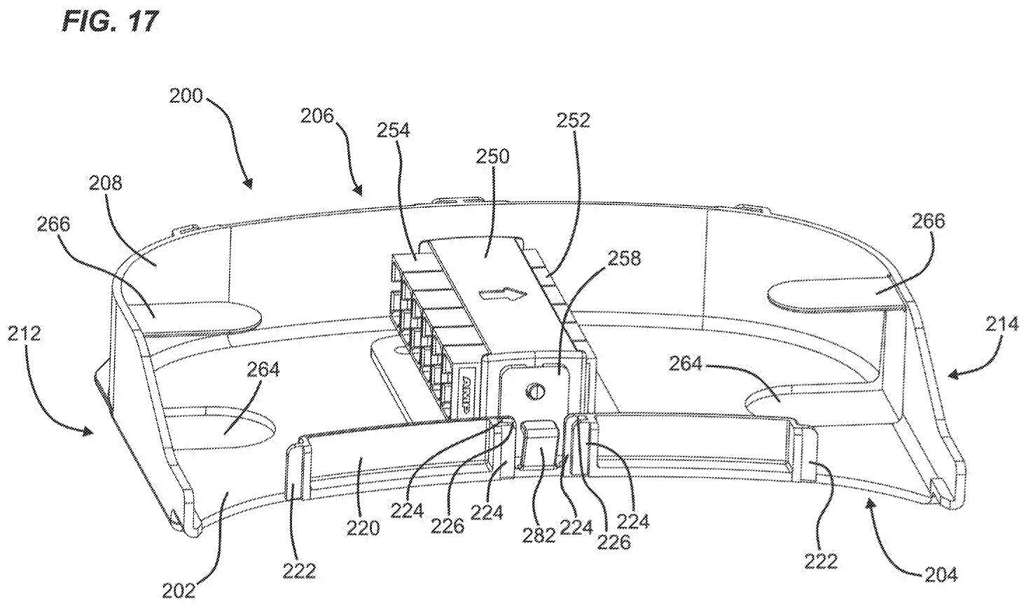

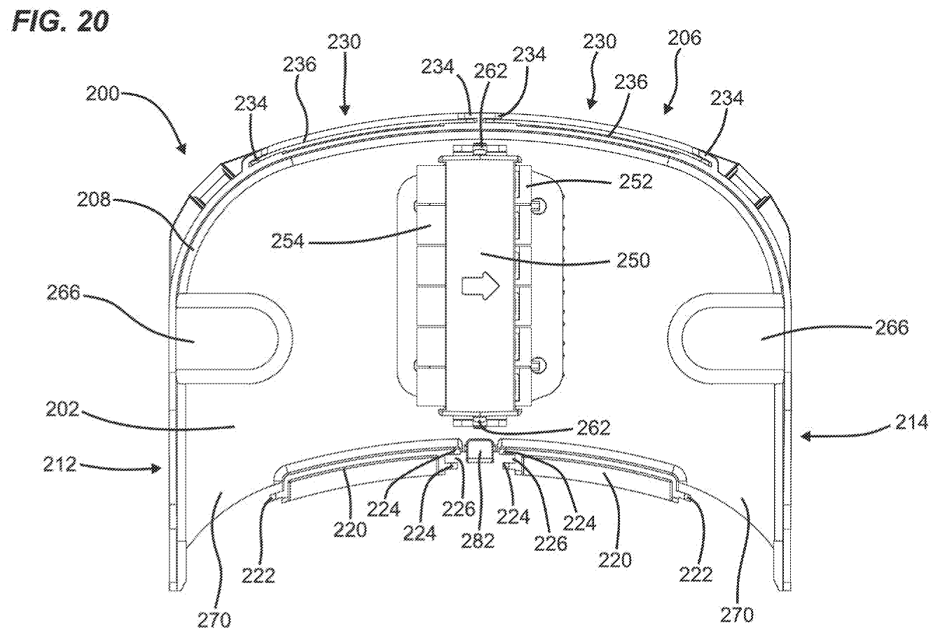

FIG. 17 is an isometric view of the modular extension 200. FIG. 20 is a top view of the modular extension 200. Referring now to FIGS. 17 and 20, the modular extension 200 includes a base 202 that extends between a proximal end 204 and a distal end 206, and between opposite lateral sides 212, 214. The modular extension 200 further includes a sidewall 208 that surrounds at least the distal end 206 and the lateral sides 212, 214 of the base 202.

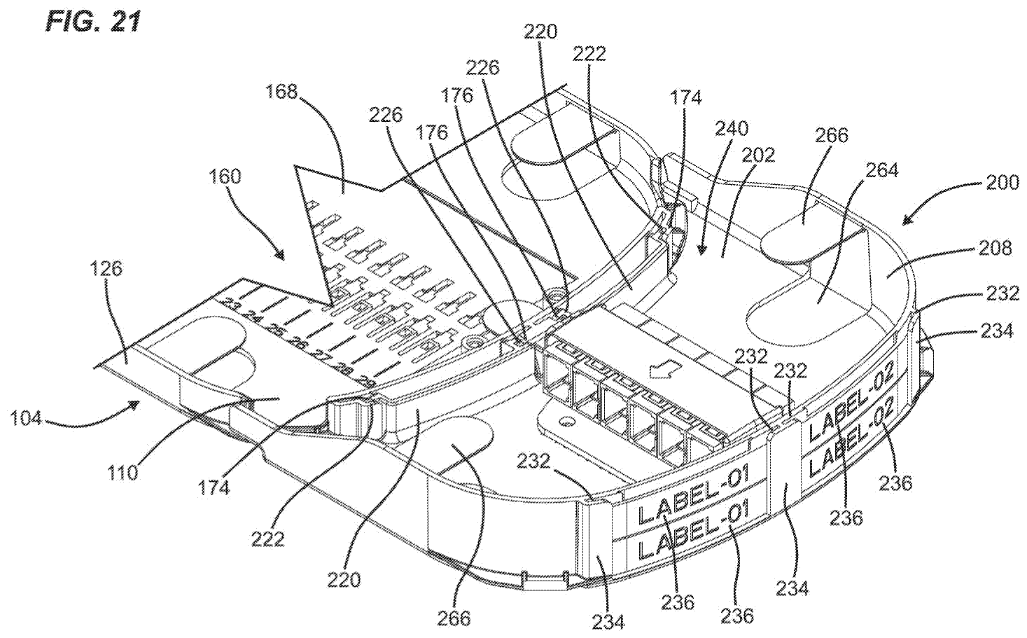

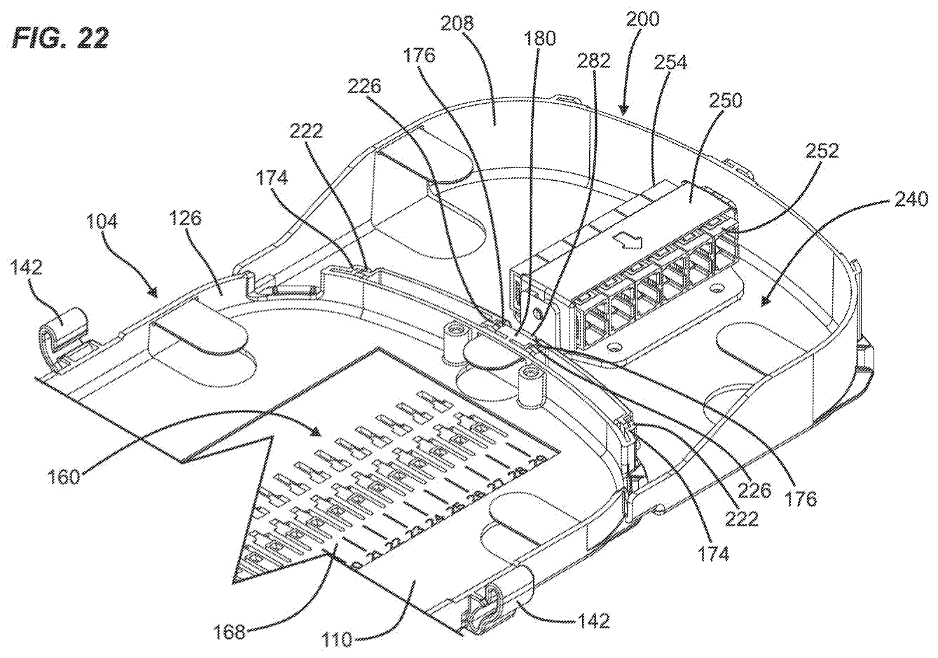

FIGS. 21 and 22 are isometric views of the tray 104 with the modular extension 200 attached thereto. Referring now to FIGS. 16, 17, 21, and 22, the modular extension 200 includes one or more projections 220 that extend orthogonally from the base 202 at the proximal end 204. The projections 220 each include tabs 222 that slide into the slots 174 at the distal end 114 of the tray 104. The projections 220 further include tabs 224 that define slots 226 that receive the tabs 176 on the sidewall 126. In the embodiment depicted in the figures, the tabs 222, 224 are positioned on opposite sides of each projection 220. Alternative arrangements are possible such as where the modular extension 200 includes a single projection 220 instead of a pair of projections 220. Also, the one or more projections may include only the tabs 222, or alternatively, may include only the tabs 224, or may include any combination thereof.

The modular extension 200 further includes a tab 282 that snap fits into the receptacle 180 on the tray 104. Accordingly, the modular extension 200 is removably attachable to the distal end 114 of the tray 104 to extend the length and storage capacity of the tray.

FIG. 23 is a side view of the modular extension 200. Referring now to FIG. 23, the sidewall 208 of the modular extension 200 has a height H2. The height H2 of the modular extension 200 is larger than the height H1 of the tray 104 (see FIG. 9). In certain examples, the height H2 of the modular extension 200 is about twice as tall as the height H1 of the tray 104. In certain examples, the height H1 can range from about 10 mm to about 15 mm, and the height H2 can range from about 20 mm to about 30 mm.

The larger height of the sidewall 208 of the modular extension 200 allows the modular extension to provide storage for fiber optic equipment that would ordinarily not fit in the interior volume 160 of the tray 104. For example, the modular extension 200 can be used to store patch cord connectors, as will be described in more detail below.

Additionally, the larger height of the sidewall 208 of the modular extension 200 provides a space in the splice organizer 100 where another tray 104 can be nested, and thereby provides a more efficient use of the space inside the enclosure 10. For example, FIG. 4 illustrates an example where a first tray of the second type 104b is nested within a space defined by another tray of the second type 104b and the modular extension 200.

Referring now to FIGS. 20, 21, and 24, the modular extension 200 includes one or more label areas 230 for securing one or more labels 236 to the modular extension 200. The label areas 230 are similar to the label areas 124 of the tray 104. The label areas 230 are defined by the sidewall 208 at the distal end 206 of the modular extension 200, and the label areas 230 are pockets for holding the labels 236 that can be used to identify the modular extension 200 and the contents stored thereon, as well as the tray 104 to which it is attached.

The label areas 230 include at least one slot 232 that is defined by one or more tabs 234 on the sidewall 208 for securing the labels 236 to the modular extension 200. Each slot 232 can include one or more retention members that secure the labels 236 inside the label areas 230 by friction. The retention members in the slots 232 of the modular extension 200 can be similar to the retention members 184 inside the slots 172 of the tray 104, as shown in FIG. 25.

In the example depicted in the figures, the sidewall 208 includes two separate slots 232 for securing two columns of labels to the modular extension 200. Also, due to the larger height of the sidewall 208, the label area 230 may include two or more rows of stacked labels.

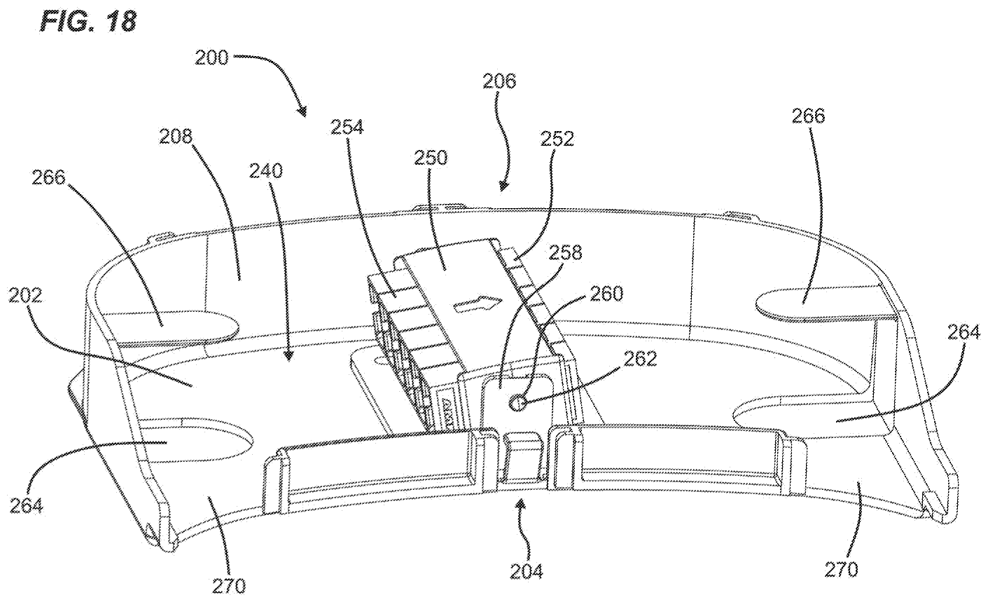

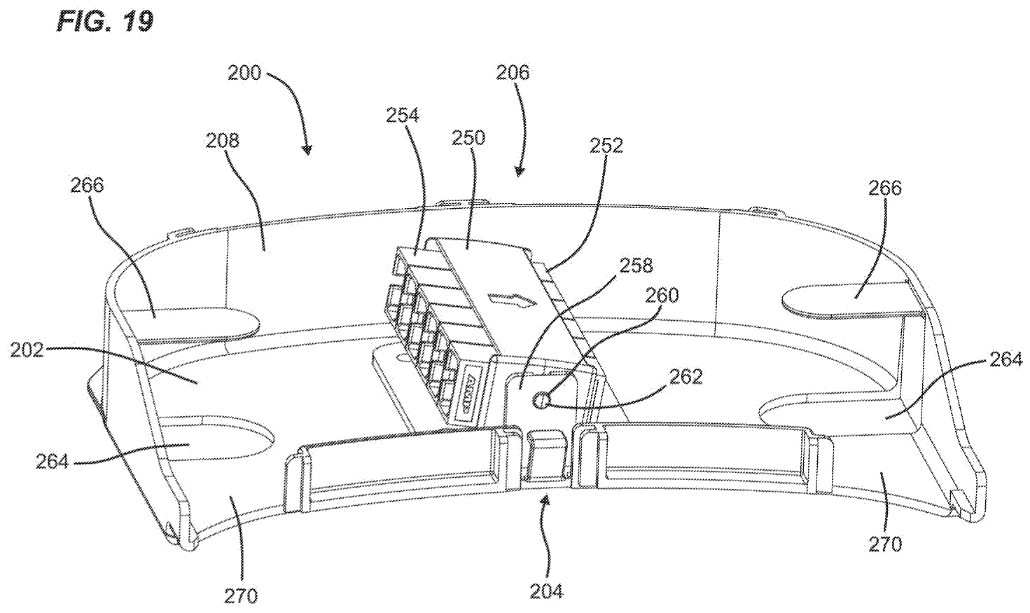

FIGS. 18 and 19 are isometric views of the proximal end 204 of the modular extension 200. Referring now to FIGS. 17-19, the base 202 and sidewall 208 together define a storage area 240 for storing fiber optic splices, devices, tools, equipment, and the like. In certain examples, the storage area 240 can be used to store a plurality of patch cord connectors.

The storage area 240 includes a platform 250 having first and second rows of adapters 252, 254. As shown in the exploded view of FIG. 24, connectors 268 can be inserted into the first and second rows of adapters 252, 254 for storing the connectors 268 in the storage area 240 of the modular extension 200. In certain examples, first and second rows of adapters 252, 254 are configured to store a plurality of patch cord connectors in the storage area 240.

The first row of adapters 252 are positioned on a first side of the platform 250, and the second row of adapters 254 are positioned on an opposite, second side of the platform 250. The platform 250 is pivotally connected to a bracket 258 that extends orthogonally from the base 202. In certain examples, the bracket 258 is attached to the base 202 by one or more fasteners such as screws. The bracket 258 includes apertures 260 on opposite sides, and the platform 250 includes pins 262 that extend axially. The pins 262 of the platform 250 are inserted into the apertures 260 of the bracket 258, and allow the platform 250 to rotate in clockwise and counterclockwise directions relative to the base 202 of the modular extension 200.

In FIG. 18, the platform 250 is partially rotated in the counterclockwise direction which causes the first row of adapters 252 to pivot upwards. This can help improve the accessibility of the first row of adapters 252 (and any type of connectors held therein) by allowing a technician to reach with their fingers underneath the first row of adapters 252.

In FIG. 19, the platform 250 is partially rotated in the clockwise direction which causes the second row of adapters 254 to pivot upwards. This can help improve the accessibility of the second row of adapters 254 (and any type of connectors held therein) by allowing a technician to reach with their fingers underneath the second row of adapters 254.

In addition to the platform 250 that is pivotally rotatable, the modular extension 200 further includes apertures 264 that extend through the base 202 for providing additional access to the first and second rows of adapters 252, 254. For example, a technician can place their fingers through the apertures 264 from the bottom of the modular extension 200 to reach underneath the first and second rows of adapters 252, 254 (and any type of connectors held therein).

Also, the modular extension 200 can include guide tabs 266 that extend from the sidewall 208 across a portion of the base 202. The guide tabs 266 can aid in retaining slack portions of the fiber optic cables such as patch cords within the modular extension 200.

Referring now to FIGS. 16, 21, and 22, the sidewall 126 at the distal end 114 of the tray 104 has one or more openings 170 that correspond with one or more openings 270 at the proximal end 204 of the modular extension 200 to provide access from the interior volume 160 of the tray 104 to the storage area 240 of the modular extension 200. The openings 170, 270 can allow fiber optic cables, such as patch cord cables, to extend through the interior volume 160 of the tray 104, and allow the connectors that terminate the cables to be stored in the adapters on the platform 250 inside the storage area 240 of the modular extension 200.

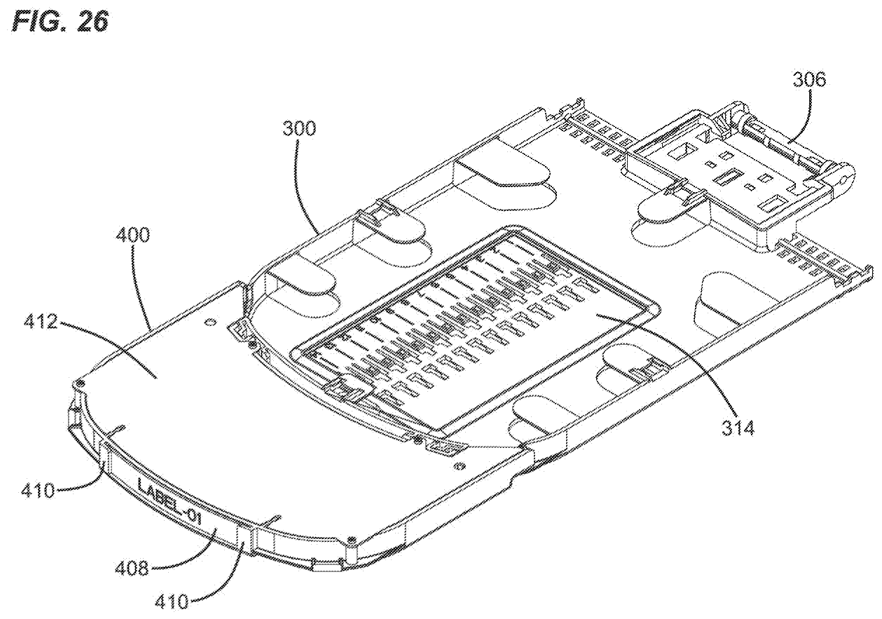

FIG. 26 is an isometric view of another example of a modular extension 400 attached to a tray 300. Like in the examples described above, the tray 300 can be pivotally attached to the mounting bracket 102 of the splice organizer 100 shown in FIG. 1. For example, the tray 300 includes a hinge 306 that can pivotally attach the tray 300 to the mounting bracket 102. Also, the tray 300 includes a splicing area 314 for securing a plurality of splice holders.

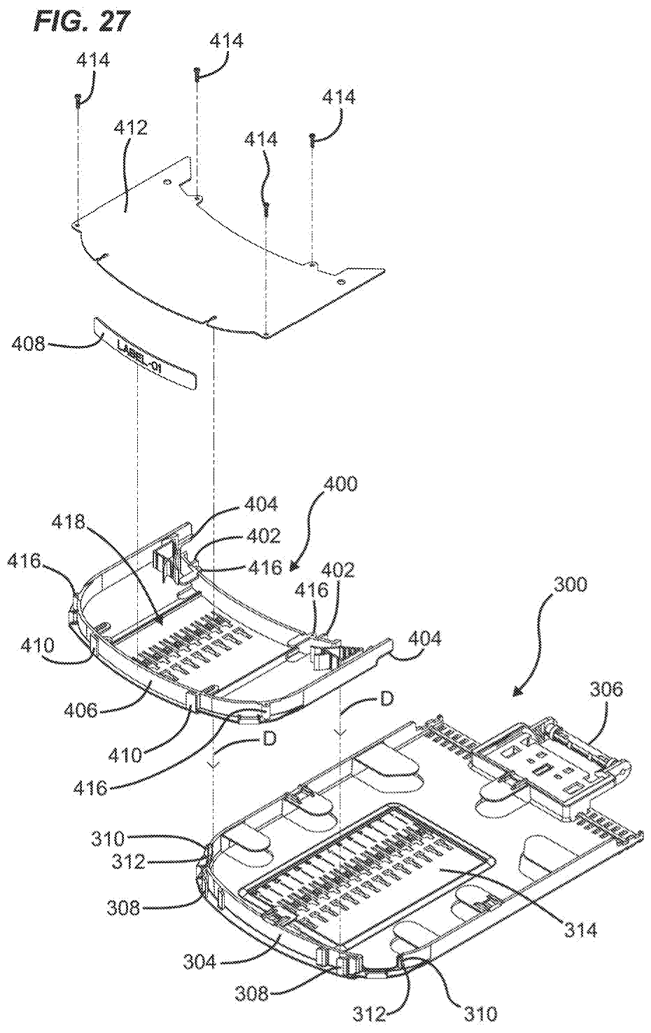

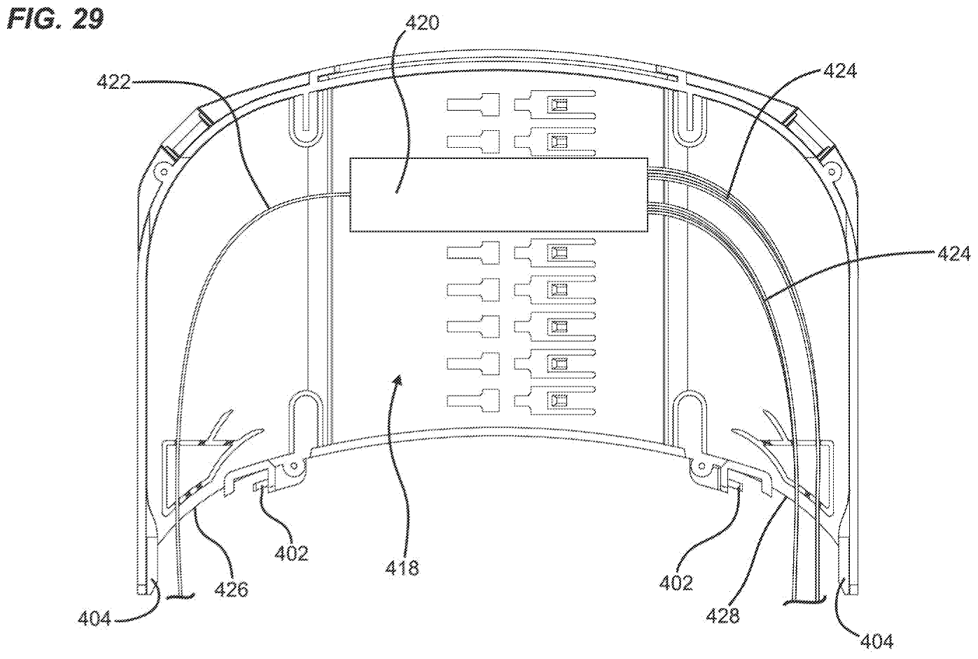

FIG. 27 is an exploded isometric view of the modular extension 400 and the tray 300. Referring now to FIGS. 26 and 27, the modular extension 400 attaches to a distal end 304 of the tray 300 in a similar fashion as the modular extension 200 and tray 104 described above. For example, the modular extension 400 includes tabs 402 (see FIG. 29) that engage tabs 308 located at the distal end 304 of the tray 300 to prevent the modular extension 400 from being pulled off the tray 300 in a direction orthogonal to the arrows D shown in FIG. 27.

Additionally, the modular extension 400 includes surfaces 404 (see FIG. 29) that are each configured to engage a corresponding ramped surface 310 on opposite sides of the distal end 304 of the tray 300 when the modular extension 400 is pushed down toward the tray 300 in the direction of the arrows D shown in FIG. 27. Each surface 404 slides along the corresponding ramped surface 310 until reaching a point past a shoulder 312 of each corresponding ramped surface 310, which prevents the modular extension 400 from being pulled off the tray 300 in a direction parallel to the arrows D shown in FIG. 27. In this example, the modular extension 400 snap-fits into the distal end 304 of the tray 300. In alternative examples, the modular extension 400 can attach to the distal end 304 of the tray 300 by using other attachment mechanisms such as by using one or more fasteners to secure the modular extension 400 to the tray 300.

The modular extension 400 includes at least one label area 406 at a distal end. The at least one label area 406 is configured to hold a label 408 for identifying the modular extension 400 and the tray 300, and the contents stored thereon. The at least one label area 406 can include tabs that define a pocket for holding the label 408 at a distal end of the modular extension 400.

The modular extension 400 includes a cover 412 that encloses an interior volume 418. In the example shown in the figures, the cover 412 attaches around a perimeter of the modular extension 400 using one or more fasteners 414. The fasteners 414 are screws that screw into apertures 416 on the modular extension 400 to secure the cover 412 to the modular extension 400. Alternative types of fasteners may be used to secure the cover 412 to the modular extension 400 such as additional types of mechanical fasteners, and adhesives such as glue or epoxy.

In some examples, the cover 412 is permanently attached to the modular extension 400 to prevent end users from having access to the interior volume 418. In such examples, the cover 412 can be permanently glued to the modular extension 400.

Alternatively, the cover 412 can be non-permanently attached such that the cover 412 can be removed from the modular extension 400 to provide access to the interior volume 418 as may be needed by an end user. In such examples, the cover 412 can be attached to the modular extension 400 using one or more mechanical fasteners such as screws.

The interior volume 418 provides a storage area for storing fiber optic equipment such as fiber optic connectors, adapters, splitters, and wave division multiplexers. In some examples, the interior volume 418 includes one or more fiber optic splitters. In other examples, the interior volume 418 includes one or more wave division multiplexers. In further examples, the interior volume 418 includes at least one fiber optic splitter and at least one wave division multiplexer. Additional combinations of fiber optic equipment can be stored in the interior volume 418, and these combinations of equipment are provided by way of example.

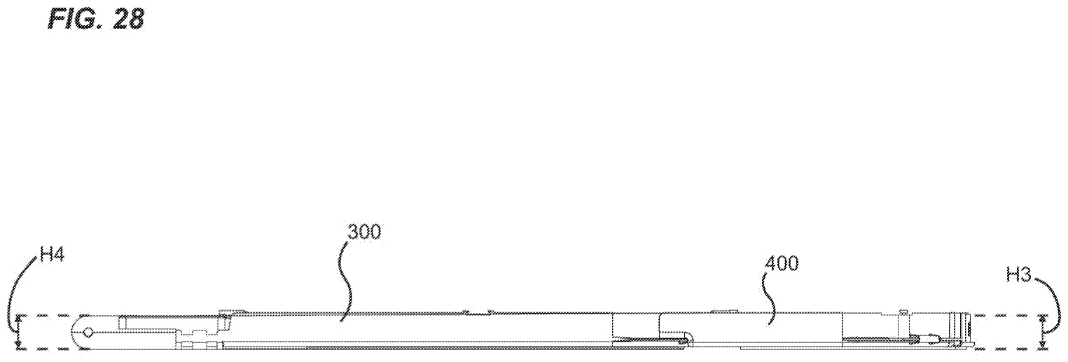

FIG. 28 is a side view of the modular extension 400 and the tray 300. As shown in FIG. 28, the modular extension 400 has a height H3 that is substantially similar or the same as a height H4 of the tray 300. Thus, top and bottom surfaces of the modular extension 400 are substantially flush and continuous with top and bottom surfaces of the tray 300.

FIG. 29 is a top view of the modular extension 400 with the cover 412 removed therefrom, exposing a fiber optic splitter 420 secured inside the interior volume 418 of the modular extension 400. At least one splitter input 422 enters the fiber optic splitter 420 from one side, and a plurality of splitter outputs 424 exit the fiber optic splitter 420 from an opposite side. As shown in FIG. 29, the at least one splitter input 422 enters the interior volume 418 through an opening 426 on one side of the modular extension, while the plurality of splitter outputs 424 exit the interior volume 418 through an opening 428 on an opposite side of the modular extension. In the example illustrated in the figures, the fiber optic splitter 420 is a 1×8 splitter such that the at least one splitter input 422 is split into 8 splitter outputs. Additional types of fiber optic splitters may be stored and secured inside the interior volume 418 as well as additional types of fiber optic equipment such as wave division multiplexers, connectors, adapters, and the like.

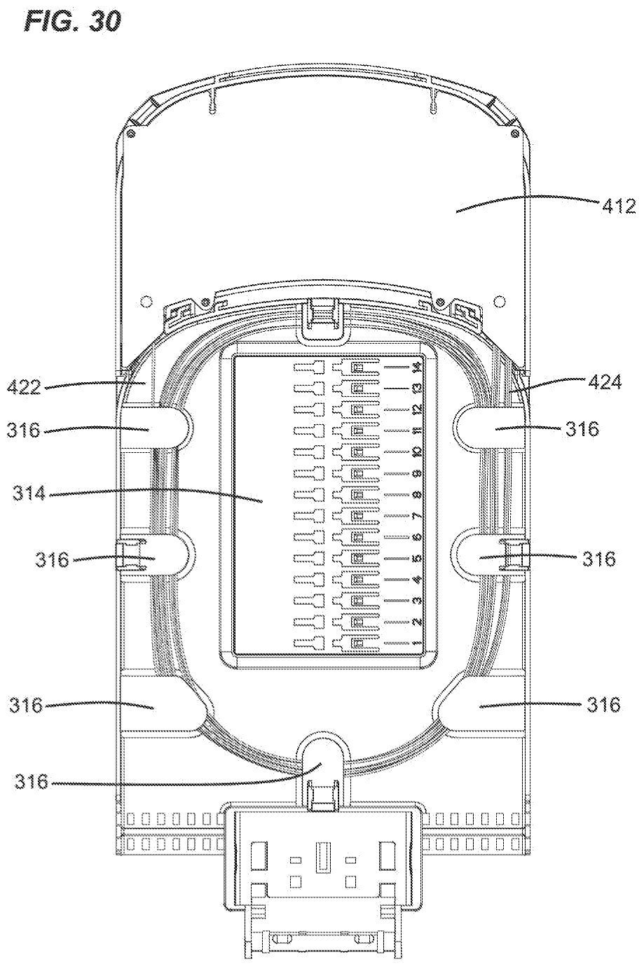

FIG. 30 is a top view of the tray 300 and modular extension 400 with the cover 412 attached thereto. As shown in FIG. 30, the splitter input 422 and splitter outputs 424 are organized by cable managers 316 on the tray 300. The cable managers 316 are similar to the cable managers 166 of the tray 104. The splitter input 422 and splitter outputs 424 can be spliced to one or more additional fiber optic cables in the splicing area 314. For example, one or more splice holders secured in the splicing area 314 can be used to splice the splitter input 422 and splitter outputs 424 to one or more additional fiber optic cables. As described above, the cover 412 can be permanently attached to the modular extension 400 to prevent end users from having access to the interior volume 418, or can be non-permanently attached.

Examples of splice enclosures with splice trays described above and shown in FIGS. 1-30 are also shown in WO2022/072680A1, the disclosure of which is hereby incorporated by reference.

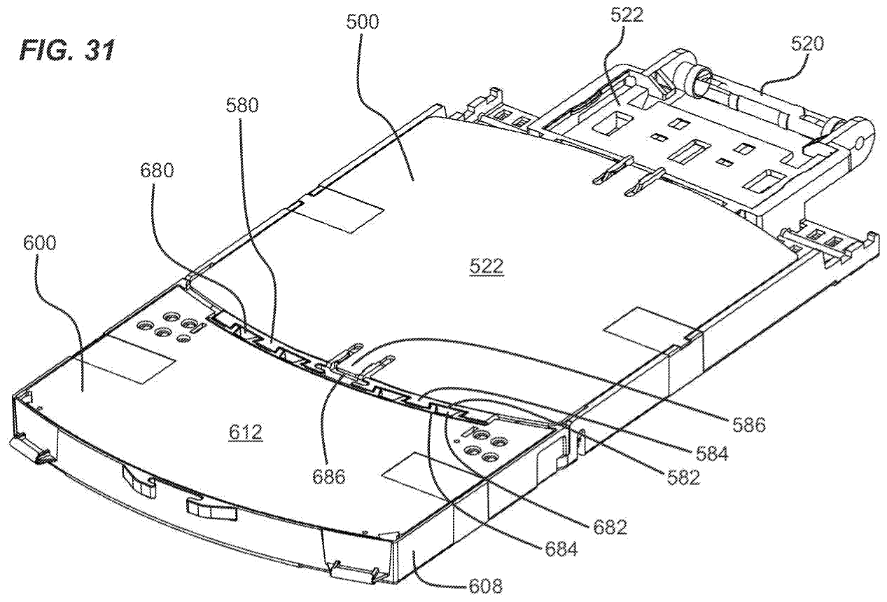

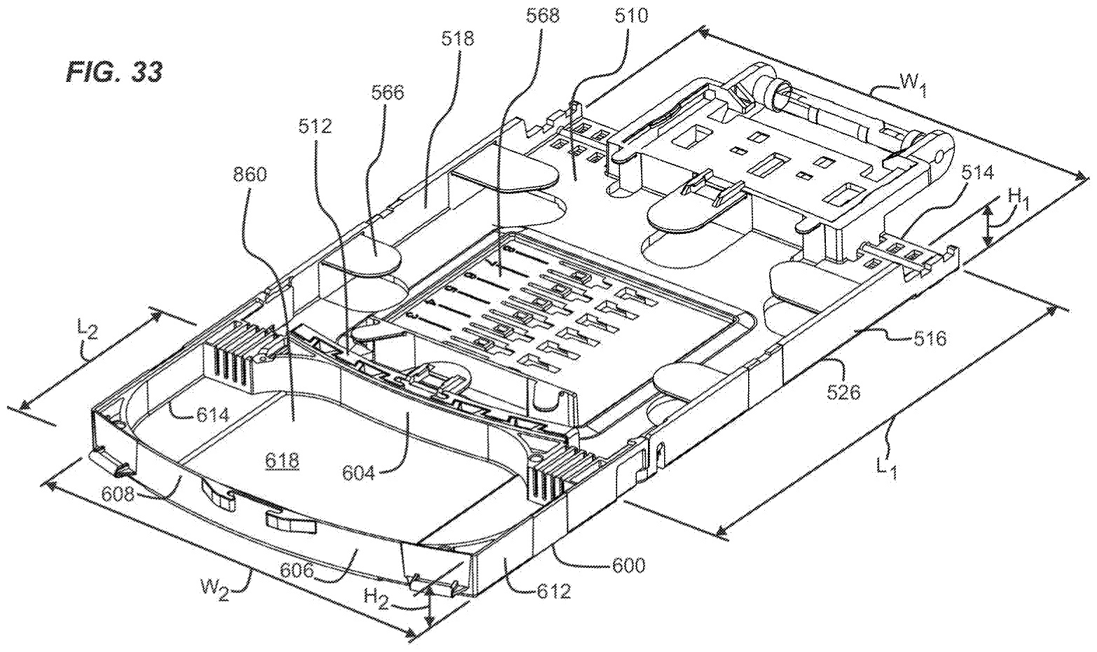

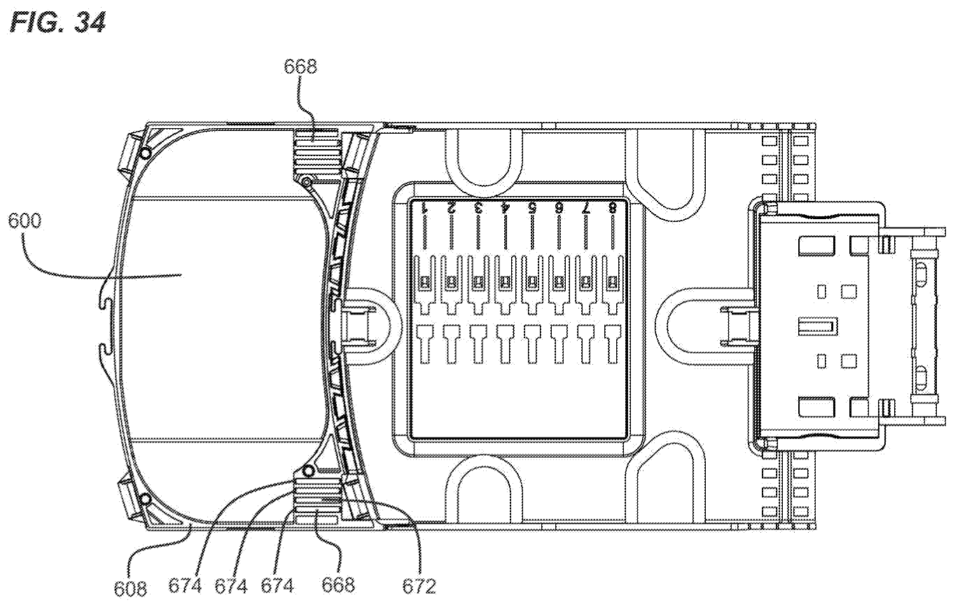

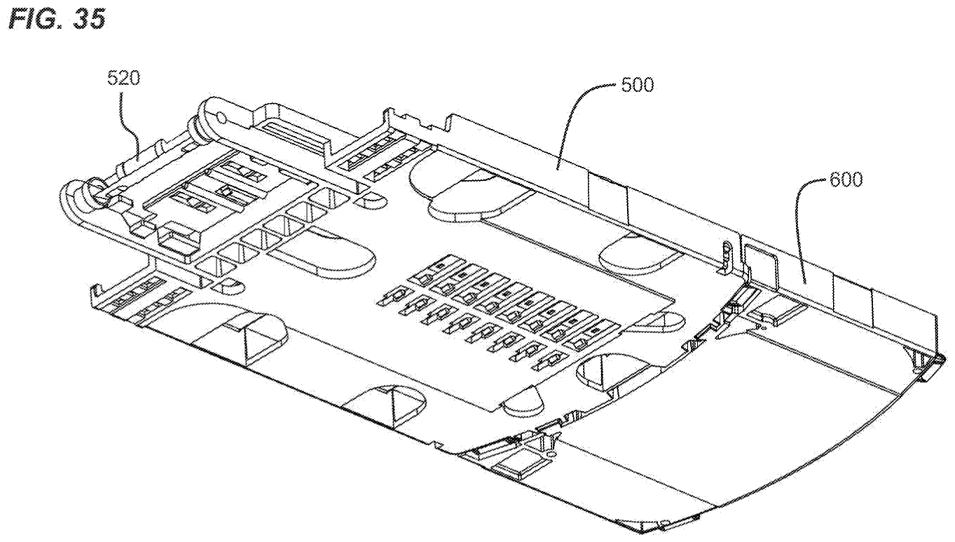

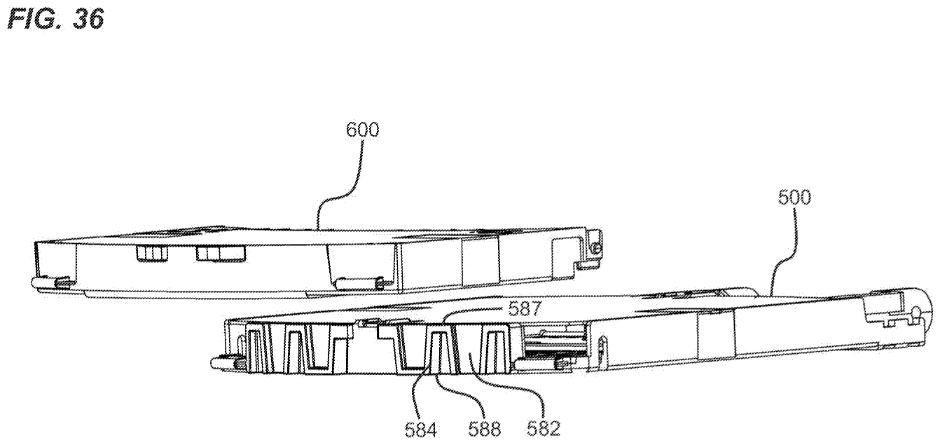

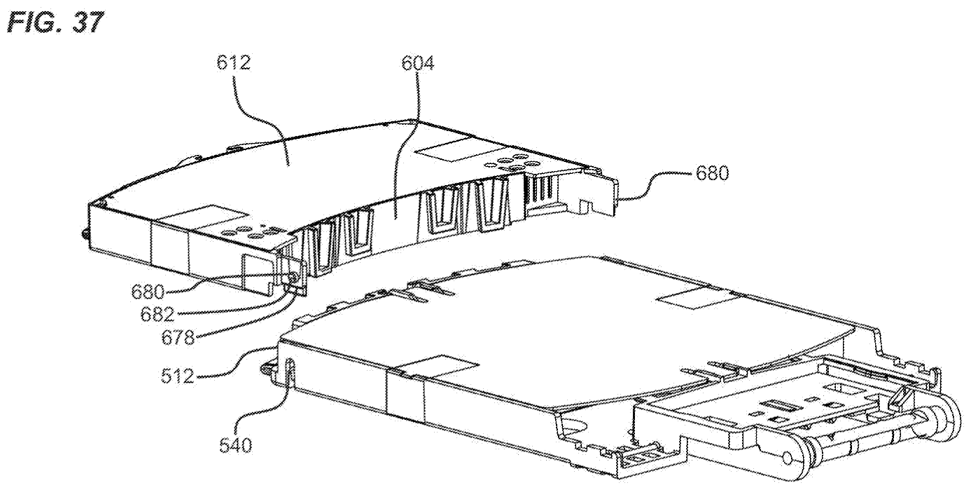

Referring now to FIGS. 31-46, another example of a fiber-optic organizer tray 500 and modular extension 600 combination is depicted in accordance with an embodiment of the disclosure. In embodiments, the tray 500 can include features similar to trays 104, 300, as described above. In embodiments, the tray 500 can include a base 510 defining a length (L1) extending between a distal end 512 to a proximal end 514 along an x-axis (as best depicted in FIG. 33), a width (W1) extending between first and second lateral sides 516, 518 along a y-axis, and a sidewall 526 at least partially surrounding the first and second lateral sides 516, 518 and the distal end 512 having a height (H1) extending upwardly from the base 510 along the z-axis, the base 510 and the sidewall 526 cooperating to define an interior volume 560 for storage of fiber-optic equipment.

With continued reference to FIG. 31, in some embodiments, the tray 500 can include a hinge 520 and a label area 522, enabling the tray 500 to be pivotably mounted to a mounting bracket (e.g., mounting bracket 102) along a hinge axis 524, so as to be pivotably movable between a stacked configuration and an un-stacked configuration. In embodiments, the tray 500 can include a cover 522 configured to be selectively coupled to the side wall 526, thereby effectively closing the interior volume 560 to seal the fiber optic equipment within the interior volume 560. In one embodiment, the interior volume 560 can house a splice holder 568 upon which a plurality of fiber optic splices can be mounted. Further, in some embodiments, the tray 500 can define one or more cable managers 566 for managing cabling within the interior volume 560.

In embodiments, the modular extension 600 can include a base 602 having a length (L2) extending between a proximal end 604 and a distal end 606 along an x-axis, a width (W2) extending between first and second lateral sides 612, 614 of the base 604 along a y-axis, and a sidewall 608 at least partially surrounding the first and second lateral sides 612, 614 and the proximal end 604, the side wall 608 having a height (H2) extending upwardly from the base 602 along the z-axis, the base 602 and the sidewall 608 cooperating to define an interior volume 860 for storing fiber optic equipment.

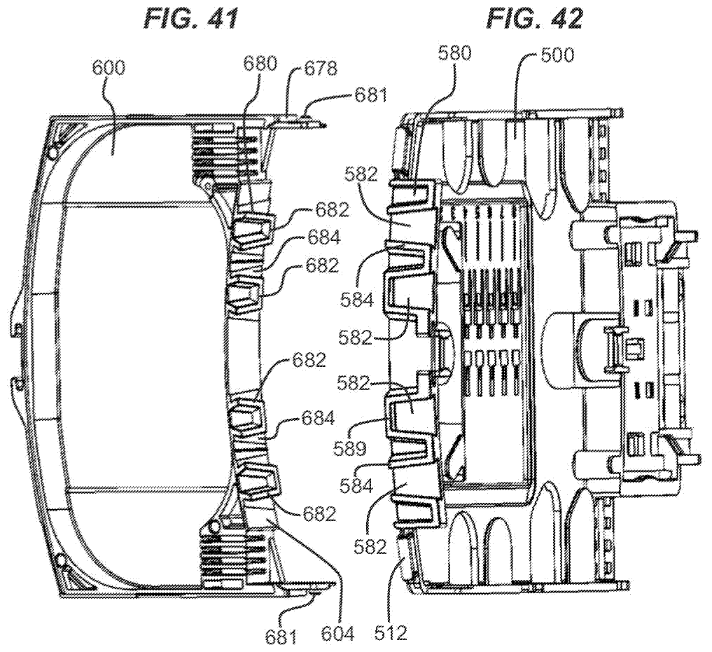

As best depicted in FIGS. 41 and 42 in some embodiments, the tray 500 and modular extension 600 can define a coupling interface including interlocking structures 580, 680. For example, in one embodiment, the tray 500 can define one or more slots 582 configured to receive one or more corresponding tabs 682 defined by the modular extension. Similarly, the modular extension 600 can define one or more slots 684 configured to receive one or more corresponding tabs 584 defined by the tray 500.

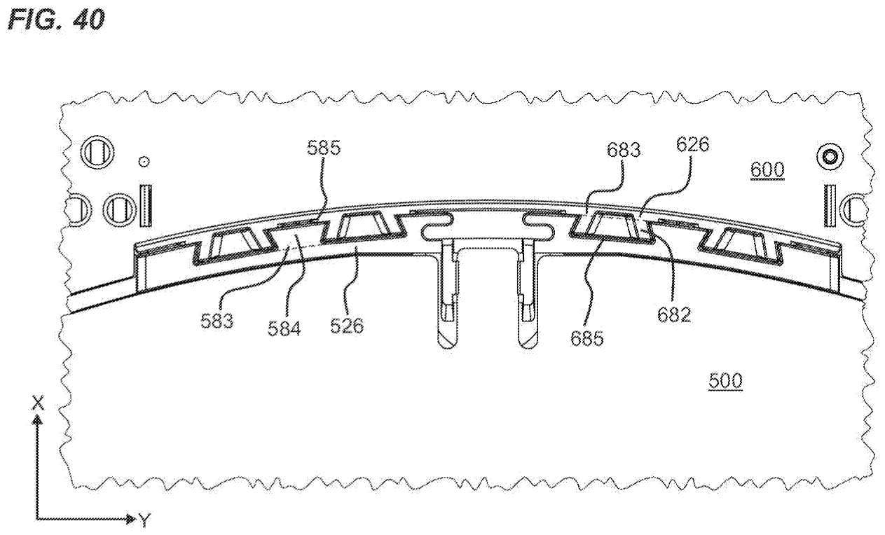

As further depicted in FIG. 40, in some embodiments, a width of the tabs 584 of the tray 500 can widen, expand or fan out as the tabs 584 extend away from the side wall 526 along the x- and y-axes, such that an outer edge 585 has a larger dimension than a base 583 of each tab 584. Similarly, a width of the tabs 682 of the modular extension 600 can widen, expand or fan out as the tabs 682 extend away from the side wall 626 along the x- and y-axes, such that an outer edge 685 has a larger dimension than a base 683 of each tab 682. The slots 582, 684 can be correspondingly shaped and sized to receive tabs 682, 584, such that the slots 582, 684 narrow or contract to generally conform to the shape of tabs 682, 584 for improved surface contact between of the tabs 682, 584 and the slots 582, 684.

For example, in some embodiments, each of the tabs 584, 682 can generally be in the form of a truncated triangle, wedge or dovetail (e.g., thereby forming a dovetail joint); although shapes of the tabs 584, 682, including a generally T-shaped tabs or Y-shaped tabs are also contemplated, provided that the outer edges 585, 685 generally have a larger dimension than the base 583, 683, thereby having the effect of inhibiting movement of the modular extension 600 relative to the tray 500 along the x- and y-axes when the interlocking structures 580, 680 are joined together.

In one embodiment, the modular extension 600 can include one or more snap arms 678, including one or more snap pins 681, which can extend from the modular extension 600 to tray 500. In some embodiments, the snap pins 681 are received in openings 540 defined by the tray 500, before the cover 512 is coupled to the tray 500. In some embodiments, pins 681 can include a ramped lower portion to facilitate inward movement of snap arms 678 until snap pins 681 are received in openings 540.

In embodiments, the proximal end 604 of the modular extension 600 can be configured to selectively couple to the distal end 512 of the tray 500 by at least one of sliding one or more of the tabs 682 defined by the modular extension 600 into the one or more dovetail slots 582 defined by the tray 500 and/or by sliding one or more of the dovetail tabs 584 defined by the tray 500 into the one or more slots 684 defined by the modular extension 600. Further, in some embodiments, the one or more snap pins 680 defined by the modular extension 600 can be slidingly received in the openings 540 defined by the tray 500, thereby securely fastening the modular extension 600 to the tray 500.

In some embodiments, at least one of the tabs 682, 584 can include a general narrowing or taper along a z-axis to inhibit passage of the tabs 682, 584 entirely through the slots 582, 684 along the z-axis. For example, each of the tabs 682, 584 can include a tapering construction, where a leading edge 687, 587 of each tab 682, 584 generally has a larger dimension than a trailing edge 688, 588 of each tab 682, 584, such that each of the tabs 682, 584 generally increase in size along the z-axis from the leading edge to the trailing edge as the interlocking structures 580, 680 are slidingly mated together, thereby inhibiting passage of the tabs 682, 584 entirely through the slots 582, 684.

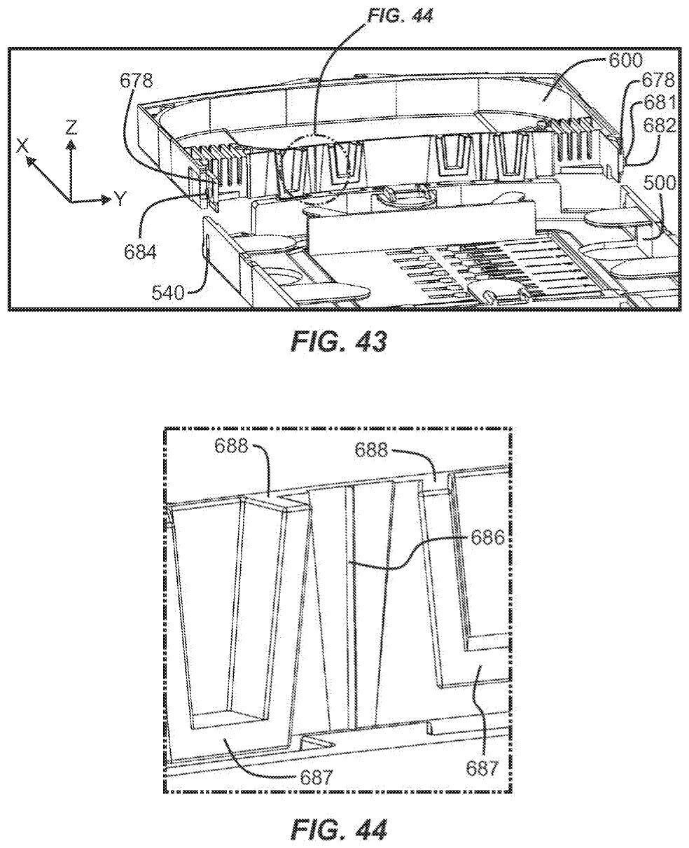

In the illustrated example, four tabs 682 are provided on the modular extension 600. As best depicted in FIG. 43, two of the four tabs 682 extend a full height (H2) of tray 500 and modular extension 600, while the other two tabs 682 include a leading edge 687 short of the full height (H2) of tray 500, which functions as a stop surface configured to make abutting contact with stop surface 589 of the tray 500 to limit travel along the z-axis, as the modular extension 600 is engaged with the tray 500. As further depicted, portions of the tabs 682, 584 and slots 684, 582 can be defined by a continuous or semi-continuous protrusion monolithically formed with and extending from the respective side walls 526, 626.

As best depicted in FIG. 44, one or more crush ribs 686 can be provided to fill any loose space between tray 500 and module or extension 600, due to manufacturing tolerances. Crush ribs 686 can be constructed of a resilient material and can be configured to deform as needed when modular extension 600 is pressed downwardly to mount the interlocking structures of tray 500 and modular extension 600, such that a natural resiliency of the material creates an interference fit between the modular extension 600 and the tray 500, thereby taking up (e.g., filling) any tolerance gap between the modular extension 600 and the tray 500.

In embodiments, the sidewall 608 of the modular extension 600 can at least partially surround the base 602 to define a storage area 640. In embodiments, the modular extension 600 can define an interior volume 618 that provides a storage area 644 storing fiber optic equipment including connectors, adapters, splitters, and wave division multiplexers. As best depicted in FIGS. 17-24, in some embodiments, the storage area 640 can include a platform 250 including a row of adapters 252, 254.

In one embodiment, the sidewall 526 defined by the tray 500 can have a first height (H1), and the sidewall 608 of the modular extension 600 can have a second height (H2), wherein the second height is larger than the first height. For example, in one embodiment, the second height (H2) can have a dimension that is about double that of the first height (H1), wherein the terms “about” or “substantially” includes dimensions having a tolerance of ±5% of a given dimension. In other embodiments, the first height (H1) can be substantially equal to the second height (H2).

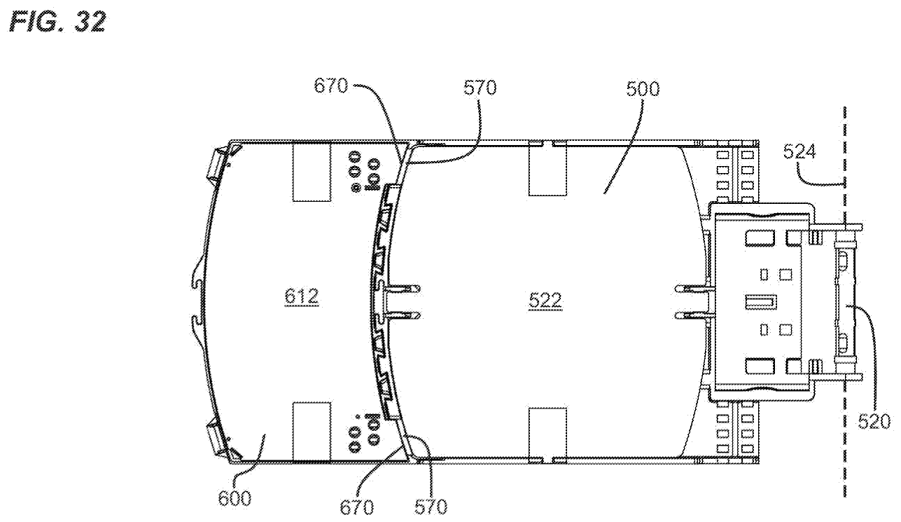

In some embodiments, the sidewall 526 at a distal end 512 of the tray 500 can define at least one opening 570 configured to provide access from an interior volume 560 of the tray 500 to the storage area 640 of the modular extension 600. In embodiments, the side wall 608 of the modular extension 600 can define a pair of openings 670 positioned on opposite lateral sides 612, 614 of the modular extension 600 (as best depicted in FIG. 32).

With reference to FIG. 34, in some embodiments, the modular extension 600 can define one or more fiber optic cable organizers 668 defining one or more slots 672 for receiving individual strands of a fiber-optic cable. For example, in one embodiment, the fiber optic cable organizer 668 can define one or more I-shaped pillars 674, which can each include a first flange portion and a second flange portion to establish a respective first and second pinch point for retention of a fiber-optic cable. For example, in one embodiment, each of the fiber-optic cable organizers 668 can include a set of three I-shaped pillars 674; although other configurations of the fiber-optic cable organizer 668 are also contemplated.

In embodiments, the module extension 600 can include telecommunications components, such as fiber optic splitters, and wave division multiplexers. In some embodiments, the modular extension 600 can include a cover 612 that can be at least one of permanently or non-permanently attached to at least one of the base 602 or side wall 608 to enclose an interior volume 618 of the modular extension 600.

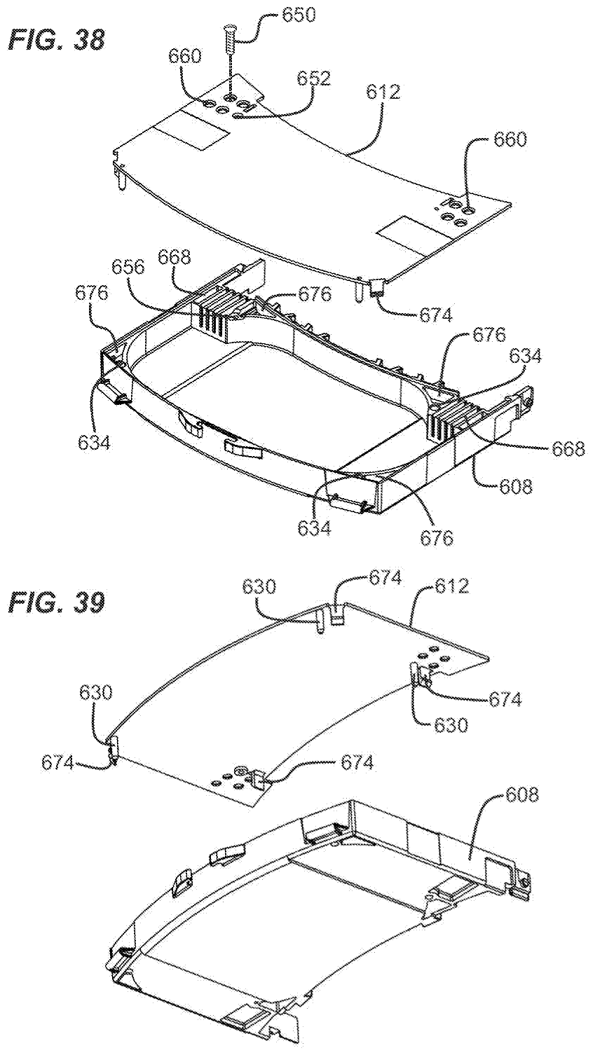

For example, in one embodiment, the cover 612 can include at least one alignment pin 630 configured to be received within a corresponding pin socket 634 defined by the modular extension 600, and generally configured to inhibit movement of the cover 612 relative to the base 602 along the x- and y-axes. For example, as depicted in FIGS. 38-39, in some embodiments, the module extension 600 can include three alignment pins 630 configured to be received in three corresponding pin sockets 634; although other quantities of pins 630 and pin sockets 634 are also contemplated.

In some embodiments, the cover 612 can include at least one barbed tab 674 configured to engage with corresponding engagement surface 678 defined by the modular extension 600, configured to inhibit movement of the cover 612 relative to the base 602 along the z-axis. For example, as depicted in FIGS. 38-39, in some embodiments, the modular extension 600 can include four barbed tabs 674 configured to be engaged with depicted corresponding engagement surfaces 676 defined by the modular extension 600; although other quantities of barbed tabs 674 and engagement surfaces 676 are also contemplated.

In some embodiments, the cover 612 can define a plurality of openings 652, for example configured to receive a fastener 650 configured to couple the cover 612 to the base 602, which in some embodiments can pass through one of the plurality of openings 652 and into a fastener socket 656 defined by the base 602. In some embodiments, the cover 612 can define one or more apertures 660 configured to receive epoxy to secure cables passing through the fiber-optic cable organizers 668, thereby permanently securing the fiber-optic cables within the fiber-optic cable organizer 668.

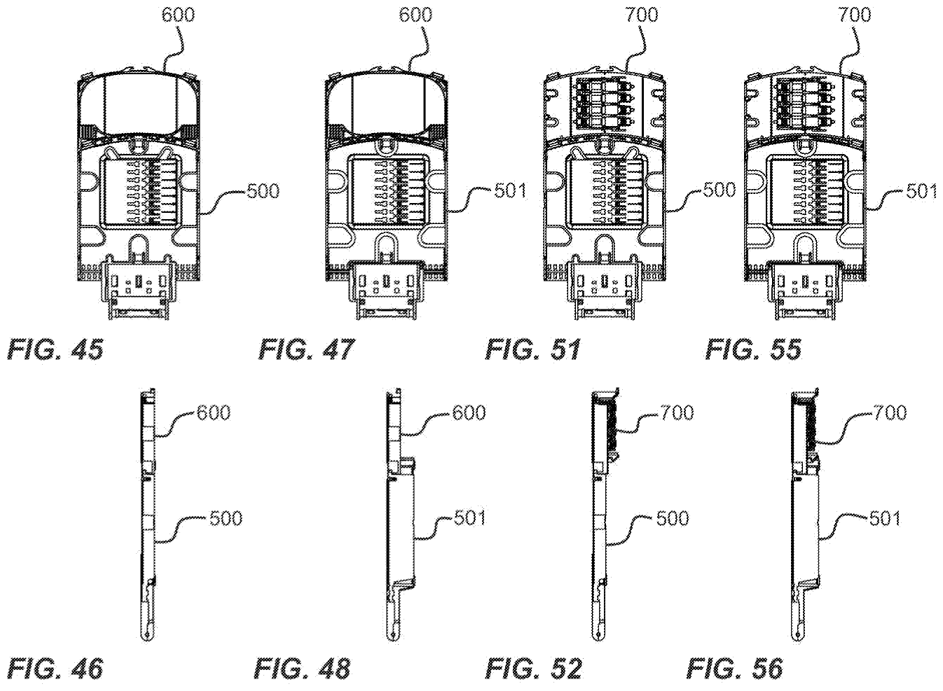

Referring to FIGS. 45-46, modular extension 600 is shown mounted to a tray 500. As depicted, the height (H1) of the tray 500 can be substantially equal to the height (H2) of the modular extension 600 (as best depicted in FIG. 46). In other embodiments, the heights between the tray 500 and the modular extension 600 can be modified for additional capacity in either of the modular extension 600 or the tray 500.

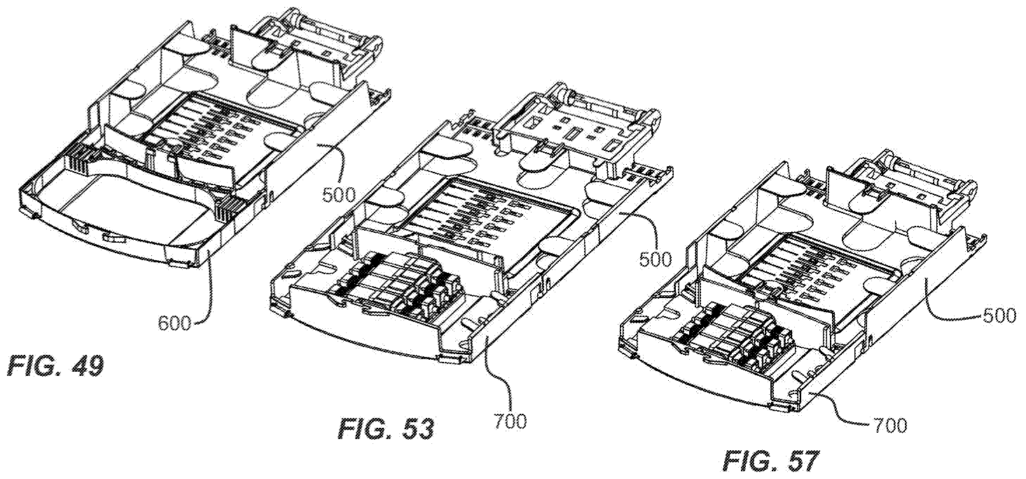

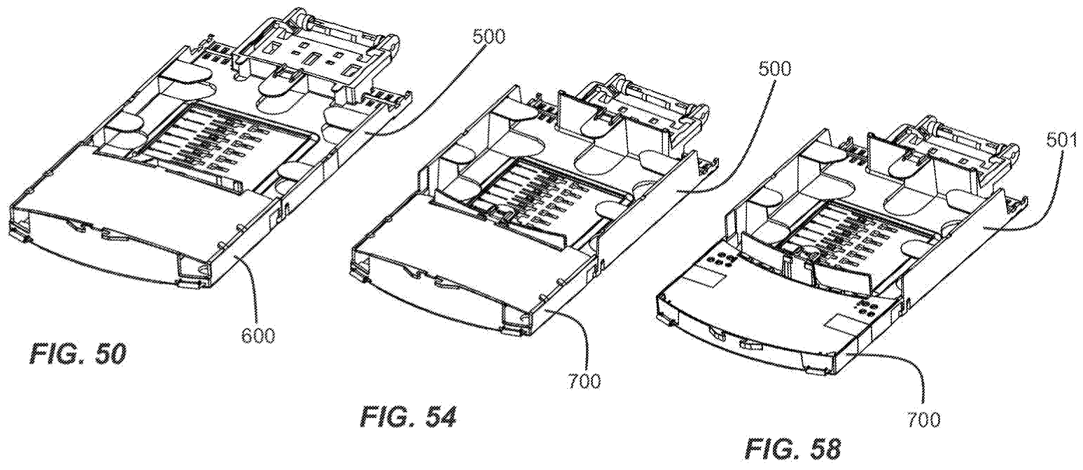

For example, FIGS. 47-50 depict a modified tray 501 operably coupled to a modular extension 600, wherein the modified tray has a height (H1) substantially double that of the height (H2) of the modular extension 600. FIGS. 51-54 depict a modified modular extension 601 operably coupled to a tray 500, wherein the modified modular extension 600 has a height (H2) substantially double that of the height (H1) of the tray 500. FIGS. 55-58 depict a modified tray 501 operably coupled to a modified modular extension 601, wherein the modified modular extension 601 and modified tray 501 have respective heights (H1) and (H2) that are substantially equal to one another, but generally double that of the unmodified tray 500 and unmodified modular extension 600. Other configurations of the trays 500 and modular extension 600 are also contemplated.

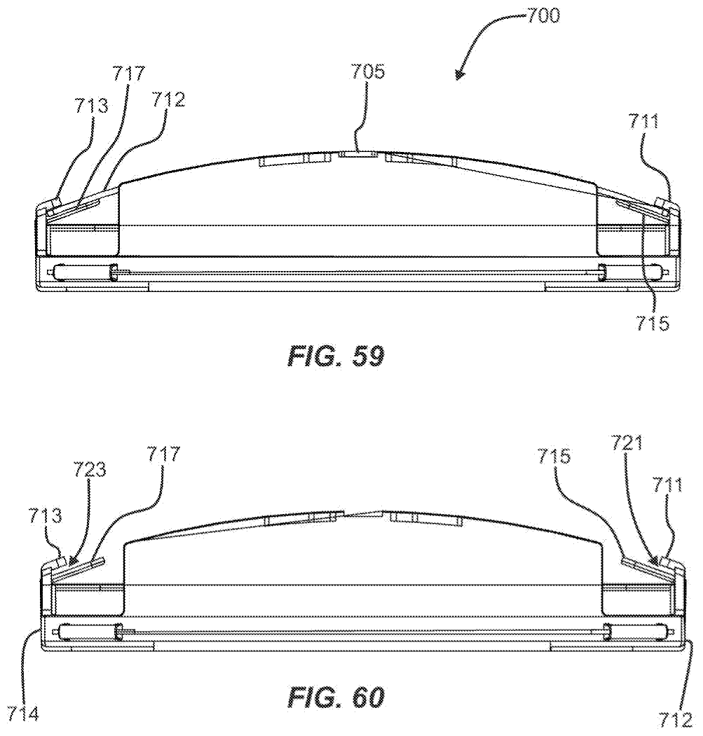

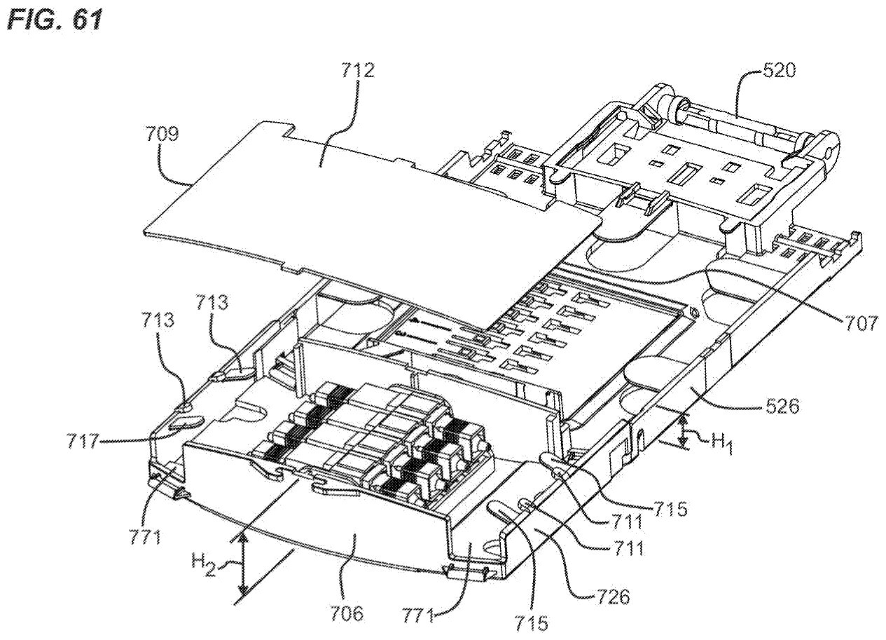

With additional reference to FIGS. 59-61, in some embodiments, the modular extension 700 can include a curved cover 712. In some embodiments, the curved cover 712 can be curved from a maximum spacing from a base 702 of the modular extension 700 to a minimum spacing from the base 702 along respective edge portions 707, 709, which can be substantially perpendicular to the hinge axis 524 of the tray 500, 501. For example, as depicted, a center portion 705 of the curved cover 712 can be taller than either edge portions 707, 709, thereby providing the cover 712 with a general curved shape in which the edge portions 707, 709 meet the sidewall 726 at a first height (H1) and the center portion 705 meet the sidewall 726 at a second height (H2), wherein the second height (H2) is greater than the first height (H1).

In some embodiments, the edge portions 707, 709 of the cover 712 can be configured to be received under side tabs 711, 713. In some embodiments, lower tabs 715, 717 can further aid in maintaining the cover 712 in position relative to the base 702. Further, in some embodiments, the lower tabs 715, 717 can be configured as cable management structures to maintain the optical cables in position relative to the modular extension 700 when the cover 712 is not present. Conversely, when the cover 712 is present, the edge portions 707, 709 can be secured within pockets 721, 723 defined by tabs 711, 713, 715, 717. The sidewall 726 at the distal end 706 of the tray 700 can define at least one opening

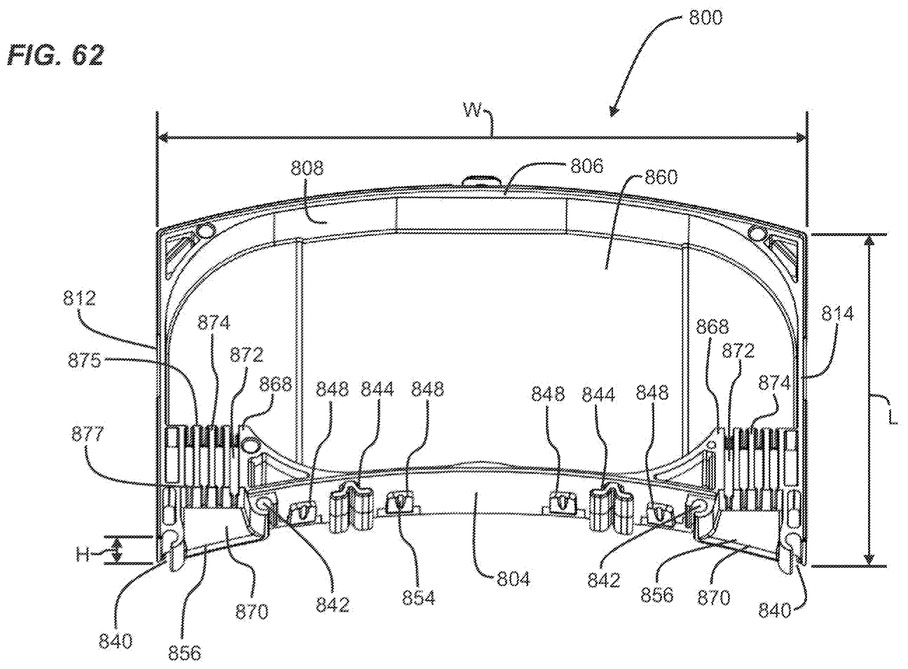

With additional reference to FIGS. 62-74, another embodiment of the modular extension 800 for a fiber-optic splice organizer tray 900 is depicted in accordance with an embodiment of the disclosure. In embodiments, the modular extension 800 can include a base 802 having a length (L) extending between a proximal end 804 and a distal end 806 along an x-axis, a width (W) extending between first and second lateral sides 812, 814 of the base 802 along a y-axis, and a sidewall 808 at least partially surrounding the first and second lateral sides 812, 814 and the proximal end 804, the sidewall 808 having a height (H) extending upwardly from the base 802 along a z-axis, the sidewall 808 and the base 802 defining an interior volume 860 for storing fiber optic equipment.

In some embodiments, the side wall 808 can define an interlocking structure configured to selectively couple the modular extension 800 to the tray 900. In some embodiments, the interlocking structure can define at least one first post receptacle 840 configured to receive at least one first post 940 defined by a respective sidewall 926 of a fiber-optic splice organizer tray 900, in proximity to a distal end 914 of the tray 900. In some embodiments, the at least one first post receptacle 840 can be configured to slidingly engage with the at least one first post 940 along the z-axis. In one embodiment, the at least one first post 940 can be keyed to fit within the at least one first post receptacle 840, so as to create a surface contacting fit about multiple sides of the at least one first post 940, thereby inhibiting relative motion between the modular extension 800 and the tray 900 along the x- and y-axes.

In some embodiments, interlocking structure can further define at least one second post receptacle 842 configured to receive at least one second post 942 defined by the sidewall 926 of the tray 900 in proximity to the distal end 914 of the tray 900. In some embodiments, the at least one second post receptacle 842 can be configured to slidingly engage with the at least one second post 942 along the z-axis. In one embodiment, the at least one second post 942 can be keyed to fit within the at least one second post receptacle 842, so as to create a surface contacting fit about multiple sides of the at least one second post 942, thereby inhibiting relative motion between the modular extension 800 and the tray 900 along the x- and y-axes.

In some embodiments, at least one first post receptacle 840 and at least one second post receptacle 842 are positioned on opposing sides of an opening 870 defined by the side wall 808 of the modular extension 800. For example, in one embodiment, the sidewall 808 of the modular extension 800 can define a pair of openings 870 positioned on opposite lateral sides 812, 814 of the modular extension 800. Accordingly, in some embodiments, the modular extension 800 defines a pair of first post receptacles 840 and a pair of second post receptacles 842 positioned on opposing sides of a pair of openings 870 positioned on opposite lateral sides 812, 814 of the modular extension 800.

In some embodiments, the modular extension 800 can further define at least one fiber-optic cable organizer 868, which can define one or more slots 872 configured to receive a fiber optic cable. For example, in one embodiment, the modular extension 800 can define one or more I-shaped pillars 874 having a first flange portion 875 in a second flange portion 877 configured to establish a respective first and second pinch point to grip a fiber optic cable. As depicted, in some embodiments, the modular extension 800 can include three I-shaped pillars 874, although other configurations of the fiber-optic cable organizer 868 are also contemplated.

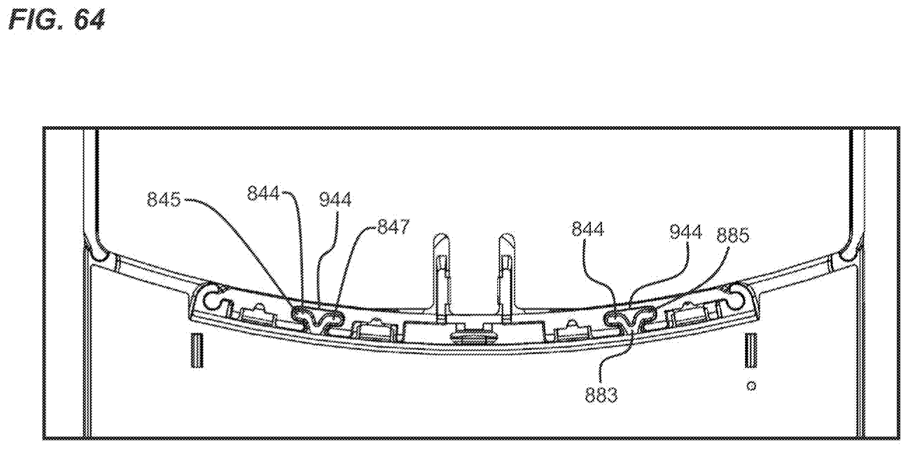

In some embodiments, the interlocking structure can define at least one shaped retaining tab 844 configured to be received within at least one shaped retention slot 944 defined by the sidewall 926 of the tray 900, which in some embodiments can be positioned in proximity to a distal end 914 of the tray 900. With additional reference to FIG. 64, in some embodiments, a cross section of the shaped retaining tab 844 can generally be T-shaped or Y-shaped, such that a width of the shaped retaining tab 844 widens, expands or fans out as the shaped retaining tab 844 extends away from the side wall 826 along the x- and y-axes, such that an outer edge 885 has a larger dimension than a base 883 of each shaped retaining tab 844. For example, in one embodiment, the shaped retaining tab 844 can include a first lateral extension 845 and a second lateral extension 847 serving as an outer edge 885 generally have a larger dimension than the base 883. Interaction between the shaped retaining tab 844 and the shaped retention slot 944 can have the effect of inhibiting relative motion between the modular extension 800 and the tray 900 along the x- and y-axes.

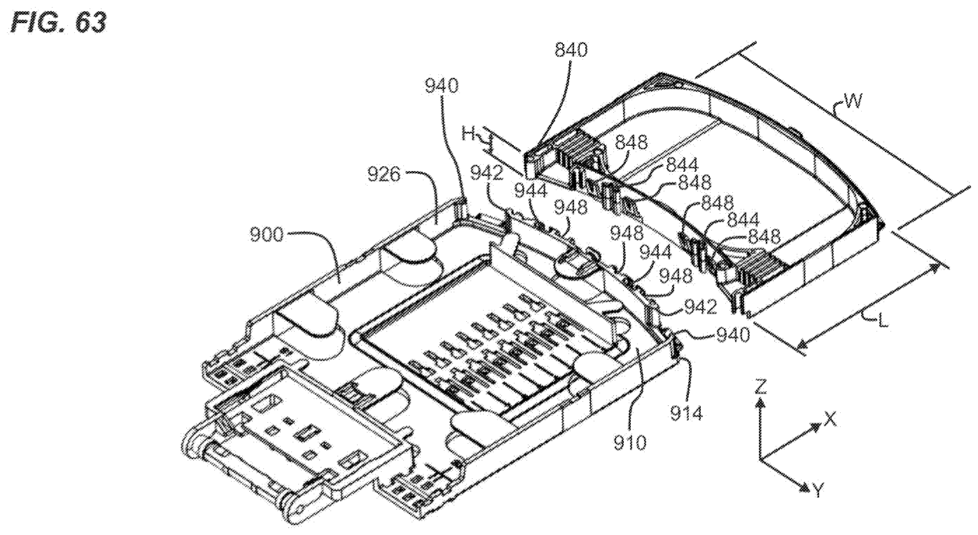

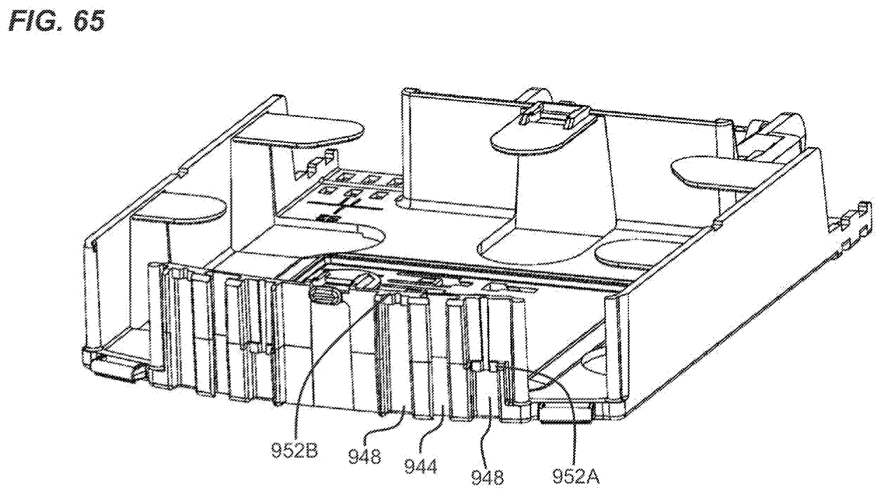

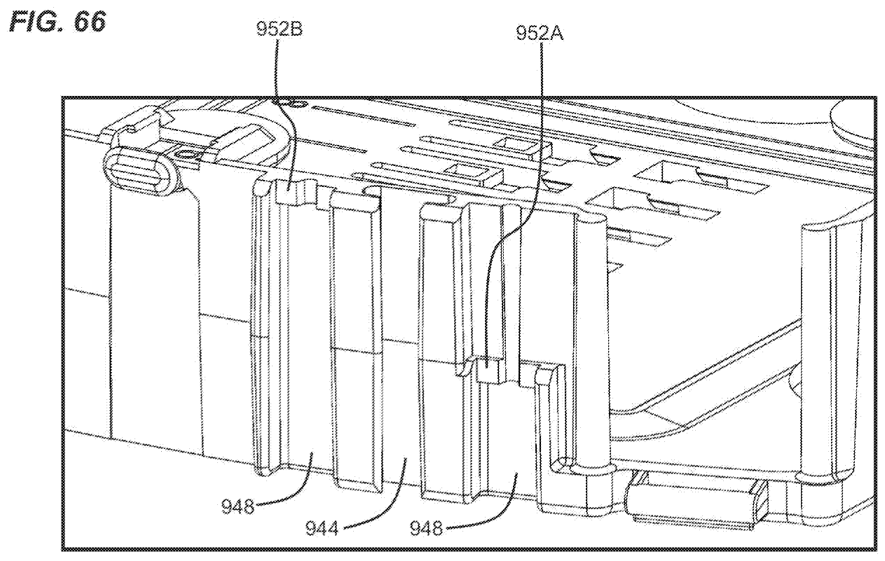

With continued reference to FIGS. 62 and 63, in some embodiments, the interlocking structure can define at least one resilient cantilevered locking tab 848 configured to be received within at least one locking tab slot 948 defined by the sidewall 926 of the tray 900. With additional reference to FIGS. 66-72, the resilient cantilevered locking tab 848 can include a cantilevered arm 850 having a distal end 852. In embodiments, the locking tab slot 948 can define a ledge portion 952 configured to deflect the cantilevered arm 850 until the distal end 852 of the cantilevered arm 850 passes over the ledge portion 952, whereupon the cantilevered arm 850 springs back under a natural material resiliency, thereby creating an abutting contact between the distal end 852 of the cantilevered arm 850 and the ledge portion 952 to inhibit movement of the modular extension 800 relative to the tray 900 along the z-axis.

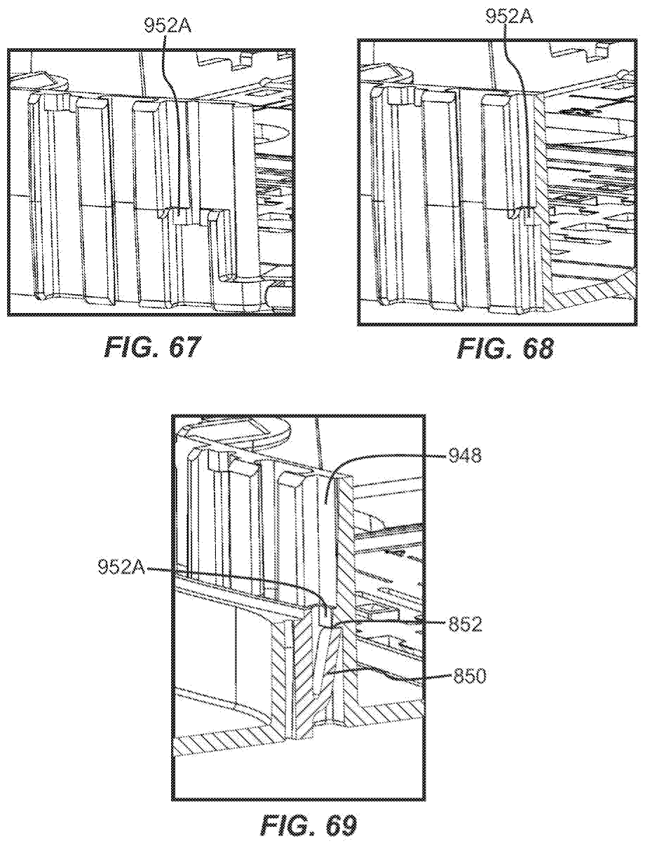

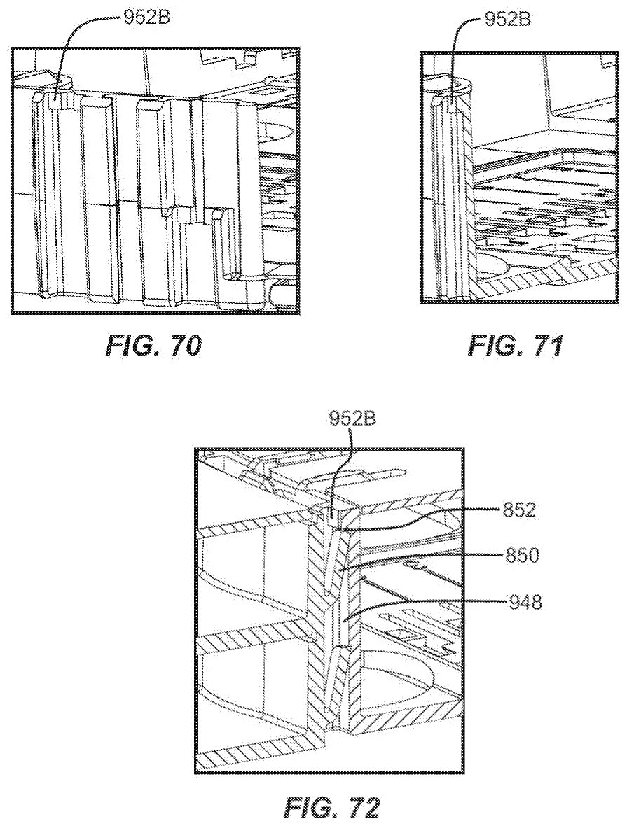

For example, as depicted in FIGS. 65, in some embodiments, the tray 900 can have a height (H2) substantially double that of the height (H1) of the modular extension 800, such that two modular extensions 800A/800B can be mounted to a single tray 900. In such an embodiment, the tray 900 can define multiple locking tab slots 948 with ledge portions 952 staggered along the z-axis, thereby enabling a first ledge portion 952A to interact with the cantilevered arm 850 of a first modular extension 800A (as depicted in FIGS. 67-69), and a second ledge portion 952B to interact with the cantilevered arm 850 of a second modular extension 800B (as depicted in FIGS. 70-72).

With continued reference to FIG. 62, in one embodiment, the resilient cantilevered locking tab 848 can include a tool detent 854 into which a tool can be positioned to encourage decoupling of the at least one resilient cantilevered locking tab 848 from the at least one locking tab slot 948. As depicted, in some embodiments, the modular extension 800 can define for resilient cantilevered locking tabs 848, although other quantities of resilient cantilevered locking tabs 848 are also contemplated. In some embodiments, at least one resilient cantilevered locking tab 848 can be positioned on either side of the T-shaped retaining member 844.

In some embodiments, the interlocking structure can further define at least one ledge 856 configured to interact with at least one of the base 910 or sidewall 926 of the tray 900 to inhibit movement of the modular extension 800 relative to the tray 900 along the z-axis.

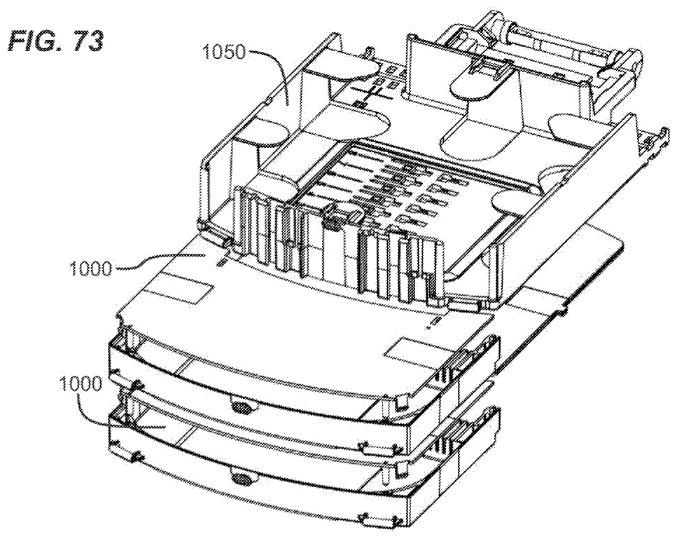

Referring to FIG. 73, another embodiment of a modular extension 1000 and tray 1050 is depicted in accordance with an embodiment of the disclosure. As depicted, a pair of modular extensions 1000 can be coupled to a single tray 1050, wherein the combined height of the pair of modular extensions 1000 is substantially equal to the height of the tray 1050.

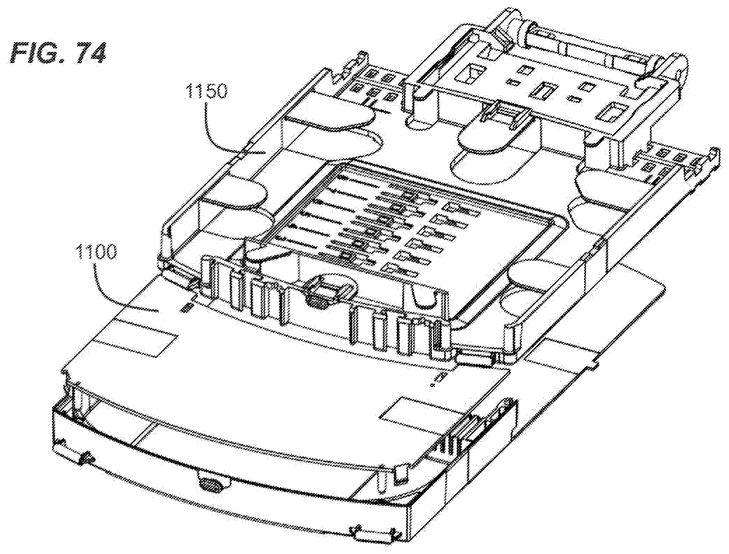

Referring to FIG. 74, another embodiment of the modular extension 1100 and tray 1150 is depicted in accordance with an embodiment of the disclosure. As depicted, a single modular extension 1100 can be coupled to a single tray 1150, such that the height of the modular extension 1100 is substantially equal to the height of the tray 1150.

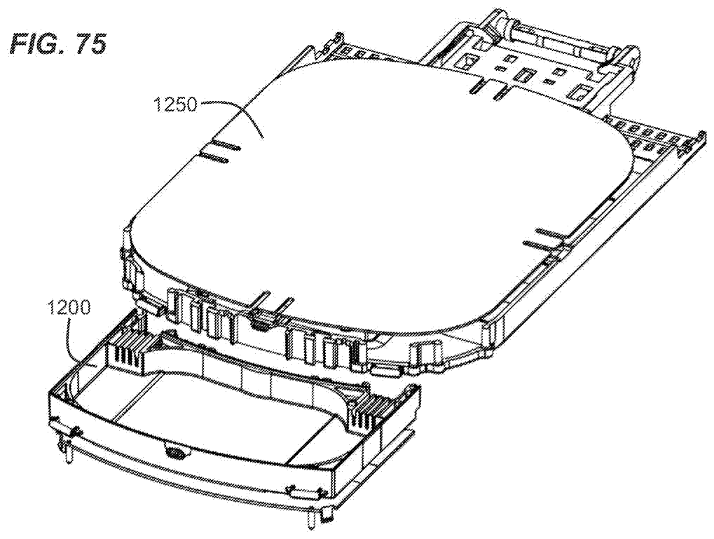

Referring to FIG. 75, another embodiment of the modular extension 1200 and tray 1250 is depicted in accordance with an embodiment of the disclosure. As depicted, in some embodiments, the modular extension 1200 can have a width that is generally narrower or smaller in dimension than a corresponding width of the tray 1250.

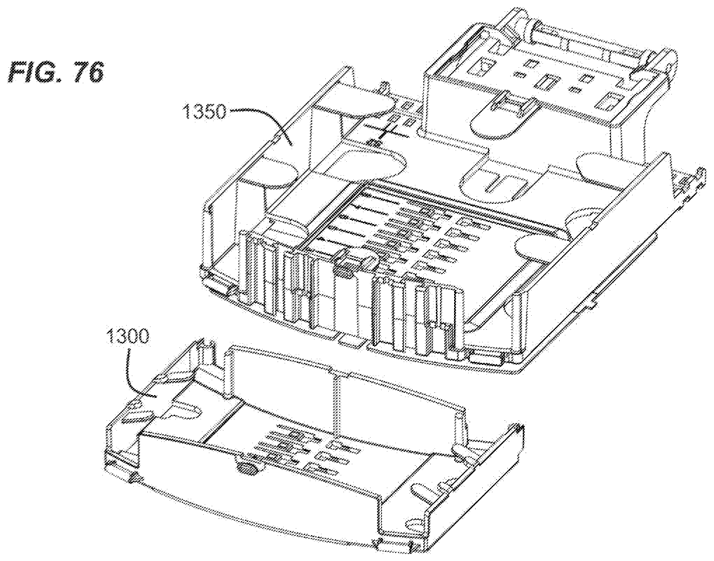

Referring to FIG. 76, another embodiment of the modular extension 1300 and tray 1350 is depicted in accordance with an embodiment of the disclosure. As depicted, in some embodiments, the modular extension 1300 can include a curved cover portion with a maximum height that is substantially equal to the height of the tray 1350.

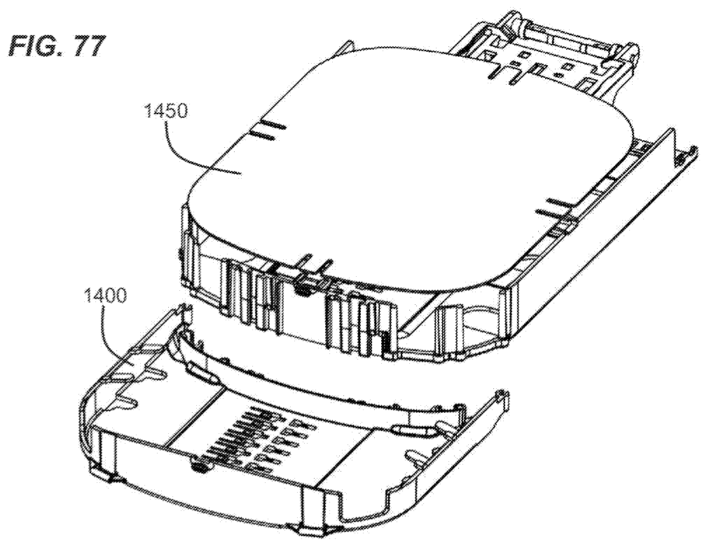

Referring to FIG. 77, another embodiment of the modular extension 1400 and tray 1450 is depicted in accordance with an embodiment of the disclosure. As depicted, in some embodiments, the modular extension 1400 can include a curved cover portion generally configured to conform to a height of the tray 1450, such that portions of the tray 1450 and the modular extension 1400 have substantially equal heights.

The various embodiments described above are provided by way of illustration only and should not be construed to be limiting in any way. Various modifications can be made to the embodiments described above without departing from the scope of the disclosure.

1-12. (canceled)

13. A modular extension for a fiber-optic splice organizer tray, comprising:
a base having a length extending between a proximal end and a distal end along an x-axis, a width extending between first and second lateral sides of the base along a y-axis, and a sidewall at least partially surrounding the first and second lateral sides and the proximal end, the sidewall having a height extending upwardly from the base, the sidewall and the base defining an interior volume, and
wherein the sidewall defines interlocking structure configured to selectively couple the modular extension to the fiber-optic splice organizer tray, the interlocking structure defining at least one T-shaped retaining member configured to be received within at least one T-shaped retention slot defined by a sidewall of the fiber-optic splice organizer tray.

14. The modular extension of claim 13, wherein the interlocking structure defines the at least one T-shaped retaining member configured to be received within the at least one T-shaped retention slot defined by the sidewall of the fiber-optic splice organizer tray, which in some embodiments can be positioned in proximity to a distal end of the fiber-optic splice organizer tray.

15. The modular extension of claim 13, wherein the at least one T-shaped retaining member includes a first extension and a second extension.

16. The modular extension of claim 13, wherein the at least one T-shaped retaining member is configured to be slidingly received within the at least one T-shaped retention slot along a z-axis.

17. The modular extension of claim 13, wherein the at least one T-shaped retaining member is configured to inhibit relative motion between the modular extension and the fiber-optic splice organizer tray along the x-axis and the y-axis.

18. The modular extension of claim 13, further comprising at least one first post receptacle configured to receive at least one first post defined by the sidewall of the fiber-optic splice organizer tray positioned in proximity to a distal end of the fiber-optic splice organizer tray.

19. The modular extension of claim 18, wherein the at least one first post receptacle is configured to slidingly engage with the at least one first post along a z-axis.

20. The modular extension of claim 18, wherein the at least one first post receptacle is configured to inhibit relative motion between the modular extension and the fiber-optic splice organizer tray along the x-axis and the y-axis.

21. The modular extension of claim 18, further comprising at least one second post receptacle configured to receive at least one second post defined by the sidewall of the fiber-optic splice organizer tray positioned in proximity to a distal end of the fiber-optic splice organizer tray.

22. The modular extension of claim 21, wherein the at least one first post receptacle and the at least one second post receptacle are positioned on opposing sides of an opening defined by the sidewall of the modular extension.

23. The modular extension of claim 13, wherein the sidewall of the modular extension defines a pair of openings positioned on opposite lateral sides of the modular extension.

24. The modular extension of claim 23, wherein the modular extension defines a pair of first post receptacles and a pair of second post receptacles positioned on opposing sides of the pair of openings positioned on opposite lateral sides of the modular extension.

25. The modular extension of claim 13, further comprising at least one fiber-optic cable organizer defining one or more slots for receiving a fiber optic cable.

26. The modular extension of claim 25, wherein the at least one fiber-optic cable organizer defines one or more I-shaped pillars having a first flange to portion and a second flange portion to establish a respective first and second pinch point for retention of the fiber optic cable.

27. The modular extension of claim 25, wherein the at least one fiber-optic cable organizer defines three I-shaped pillars.

28. The modular extension of claim 25, wherein the at least one fiber-optic cable organizer is positioned adjacent to an opening defined by the sidewall of the modular extension.

29. The modular extension of claim 13, wherein the interlocking structure further defines at least one resilient cantilevered locking tab configured to be received within at least one locking tab slot defined by the sidewall of the fiber-optic splice organizer tray.

30. The modular extension of claim 29, wherein the at least one resilient cantilevered locking tab includes a cantilevered arm having a distal end.

31. The modular extension of claim 30, wherein the at least one locking tab slot defines a ledge portion configured deflect the cantilevered arm until the distal end of the cantilevered arm passes over the ledge portion, whereupon the cantilevered arm springs back under a natural material resiliency, thereby creating an abutting contact between the distal end of the cantilevered arm and the ledge portion to inhibit movement of the modular extension relative to the fiber-optic splice organizer tray along a z-axis.

32. The modular extension of claim 29, wherein the at least one resilient cantilevered locking tab includes a tool detent into which a tool can be positioned to encourage the coupling of the at least one resilient cantilevered locking tab from the at least one locking tab slot.

33. The modular extension of claim 29, wherein the modular extension includes four resilient cantilevered locking tabs.

34. The modular extension of claim 29, wherein the at least one resilient cantilevered locking tab is positioned on either side of the T-shaped retaining member.

35. The modular extension of claim 13, wherein in the interlocking structure further defines at least one ledge configured to interact with at least one of the base or side wall of the fiber-optic splice organizer tray to inhibit movement of the modular extension relative to the fiber-optic splice organizer tray along a z-axis.

36. The modular extension of claim 13, further comprising a cover.

37. The modular extension of claim 36, wherein the cover includes at least one alignment pin configured to be received in a corresponding pin socket defined by the modular extension, configured to inhibit movement of the cover relative to the base along the x- and y-axes.

38. The modular extension of claim 36, wherein the cover includes three alignment pins configured to be received within three corresponding pin sockets.

39. The modular extension of claim 36, wherein the cover includes at least one barbed tab configured to engage with a corresponding engagement surface defined by the modular extension to inhibit movement of the cover relative to the base along a z-axis.

40. A modular extension configured to be coupled to a retention slot defined by a fiber-optic splice organizer tray, the modular extension comprising:
a base having a length extending between a proximal end and a distal end along an x-axis, a width extending between first and second lateral sides of the base along a y-axis, and a sidewall at least partially surrounding the first and second lateral sides and the proximal end, the sidewall having a height extending upwardly from the base, the sidewall and the base cooperating to define an interior volume, and
wherein the sidewall defines interlocking structure configured to selectively couple the modular extension to the fiber-optic splice organizer tray, the interlocking structure defining at least one retaining tab extending from a base in proximity to the sidewall having a first dimension, to an outer edge positioned away from the sidewall having a second dimension, wherein the second dimension is larger than the first dimension such that the at least one retaining tab increases in width as it extends away from the sidewall, and wherein the at least one retaining tab is configured to be received within the retention slot defined by the fiber-optic splice organizer tray.

41. The modular extension of claim 40, wherein the at least one retaining tab is in a form of at least one of a truncated triangle, wedge, dovetail, T-shape, or Y-shape.

42. The modular extension of claim 41, wherein the at least one retaining tab is configured to be slidingly received within the retention slot defined by the fiber-optic splice organizer tray along a z-axis to inhibit relative motion between the modular extension and the fiber-optic splice organizer tray along an x- and y-axis.

43. The modular extension of claim 40, further comprising the fiber-optic splice organizer tray.

44-46. (canceled)

47. The modular extension of claim 13, further comprising the fiber-optic splice organizer tray.
